(19) United States
(12) Patent Application Publication
(10) Pub. No.: US 2022/0355986 A1
(43) Pub. Date: Nov. 10, 2022

(54) ADAPTABLE CONTAINER ASSEMBLY

(71) Applicants: Sloane BERNSTEIN, Rockville, MD (US); Brett BERNSTEIN, Rockville, MD (US)

(72) Inventors: Sloane BERNSTEIN, Rockville, MD (US); Brett BERNSTEIN, Rockville, MD (US)

(21) Appl. No.: 17/734,919

(22) Filed: May 2, 2022

Related U.S. Application Data
(60) Provisional application No. 63/184,610, filed on May 5, 2021.

(51) Int. Cl. B65D 51/18; B65D 45/20; B65D 51/24; A47J 27/04

(52) U.S. Cl. CPC B65D 51/18; B65D 45/20; B65D 51/242; A47J 27/04; A47J 2027/043

(57) ABSTRACT

An adaptable container assembly includes a container base, a container lid, and a steaming lid. The container base partially encloses a container base void that is configured to receive a food. The container base includes a first container base sidewall and a container base bottom wall. The container base bottom wall is contiguous with the first container base sidewall. The container lid is configured to enclose the container base void. The container lid includes a first container lid sidewall coupled to the first container base sidewall. The steaming lid includes a first steaming lid sidewall coupled to the first container lid sidewall. The steaming lid cooperates with the container base to enclose the container lid between the container base and the steaming lid.

### CROSS-REFERENCE TO RELATED PATENT APPLICATION

This application claims the benefit of U.S. Provisional Patent Application No. 63/184,610, filed May 5, 2021, the contents of which are herein incorporated by reference in their entirety.

### BACKGROUND

The present disclosure relates generally to the field of containers for preparing, cooking, and serving food while reducing cross-contaminations, such as from allergens.

Generally, when a diner has a particular allergy, such as a peanut allergy, the diner may indicate this allergy to an establishment. However, the diner cannot confirm that ordered food does not include any allergens related to this allergy. The food may be cross-contaminated by such allergens, and the diner may unknowingly consume the allergens or, if the diner recognizes the allergens in the food, the food must be remade by the establishment.

### SUMMARY

One embodiment relates to an adaptable container assembly includes a container base, a container lid, and a steaming lid. The container base partially encloses a container base void that is configured to receive a food. The container base includes a first container base sidewall and a container base bottom wall. The container base bottom wall is contiguous with the first container base sidewall. The container lid is configured to enclose the container base void. The container lid includes a first container lid sidewall coupled to the first container base sidewall. The steaming lid includes a first steaming lid sidewall coupled to the first container lid sidewall. The steaming lid cooperates with the container base to enclose the container lid between the container base and the steaming lid.

Another embodiment relates to an adaptable container assembly comprising a container base, a container lid, a hinge mechanism, and a steaming lid. The container base partially encloses a container base void that is configured to receive a food. The container base includes a first container base sidewall and a container base bottom wall. The container lid includes a first container lid sidewall, a second container lid sidewall contiguous with the first container lid sidewall, and a container lid top wall contiguous with the first container lid sidewall and the second container lid sidewall. The hinge mechanism is coupled to the first container lid sidewall and the first container base sidewall such that the container lid is hingedly coupled to the container base. The steaming lid includes a first steaming lid sidewall pivotably coupled to the second container lid sidewall such that the steaming lid is hingedly coupled to the container lid.

Another embodiment relates to an adaptable container assembly comprising a container base, a container lid, a pivot mechanism, a steaming lid, and a steaming lid mechanism. The container base partially encloses a container base void that is configured to receive a food. The container base includes a first container base sidewall and a container base bottom wall. The container lid includes a first container lid comprising a first container lid sidewall coupled to the first container base sidewall. The pivot mechanism pivotably coupled the first container lid sidewall to the first container base sidewall and is configured to facilitate rotation of the container lid relative to the container base so as to cause the container lid to cooperate with the container base to enclose the container base void. The steaming lid comprises a first steaming lid sidewall. The steaming lid hinge mechanism hingedly couples the first steaming lid sidewall and the first container base sidewall and is configured to facilitated movement of the steaming lid relative to the container base such that the steaming lid cooperates with the container base to enclose the container lid between the container base and the steaming lid in at least one position of the steaming lid relative to the container base.

### BRIEF DESCRIPTION OF THE DRAWINGS

The details of one or more implementations are set forth in the accompanying Figures and the description below. Other features, aspects, and advantages of the disclosure will become apparent from the description, the Figures, and the claims, in which:

FIG. 1 illustrates an exploded view of an adaptable container assembly, according to an example embodiment;

FIG. 2 illustrates a rear view of a container base of the adaptable container assembly of FIG. 1;

FIG. 3 illustrates a rear view of a container lid of the adaptable container assembly of FIG. 1;

FIG. 4 illustrates a rear view of a steaming lid of the adaptable container assembly of FIG. 1;

FIG. 5 illustrates a portion of an adaptable container assembly, according to an example embodiment;

FIG. 6 illustrates an adaptable container assembly in an open position, according to an example embodiment.

FIG. 7 illustrates the adaptable container assembly of FIG. 6 in a closed position;

FIG. 8 illustrates an adaptable container assembly, according to an example embodiment;

FIG. 9 illustrates an adaptable container assembly, according to an example embodiment;

FIG. 10 illustrates an adaptable container assembly, according to an example embodiment;

FIG. 11 illustrates a process for using an adaptable container assembly, according to an example embodiment;

FIG. 12 illustrates a process for manufacturing an adaptable container assembly, according to an example embodiment;

FIG. 13 illustrates a process for manufacturing an adaptable container assembly, according to an example embodiment;

FIG. 14 illustrates a process for manufacturing an adaptable container assembly, according to an example embodiment; and

FIG. 15 illustrates a process for manufacturing an adaptable container assembly, according to an example embodiment.

It will be recognized that some or all of the Figures are schematic representations for purposes of illustration. The Figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for an adaptable container assembly that can be used to provide a controlled environment for food preparation and serving. The various concepts introduced above and discussed in detail below may be implemented in any of numerous ways, as the described concepts are not limited to any particular manner of implementation. Examples of specific implementations and applications are provided primarily for illustrative purposes.

### I. Overview

In order to mitigate cross-contamination of allergens in food and accommodate food allergies, it may be desirable to create controlled environments for food preparation and serving. This may be done by utilizing labels or indicators of food, or designating separate spaces for allergen-free food.

Various devices may be used to mitigate contamination of food by contaminants. Implementations discussed herein are directed to an adaptable container assembly that facilitates preparation, cooking, and serving of food while minimizing cross-contamination of various food allergies. The adaptable container assembly is configured to receive food. The adaptable container assembly includes a container base which partially encloses a void. The void is configured to receive the food that is to be served, prepared, or cooked. The adaptable container assembly may also include a container lid that is configured to enclose the void. This allows for a mitigation of contaminants, such as allergens, dirt, dust, germs, viruses, raw foods, and/or non-kosher foods, from cross-contaminating the food received by the void.

In some implementations, the container lid includes holes to facilitate heat transfer to the void and allows steam to escape the void. Some implementations utilize a steaming lid. The steaming lid may be configured to enclose the container lid between the steaming lid and the container base. This may cover the holes in the container lid and mitigate the steam from escaping the container.

### II. Adaptable Container Assemblies

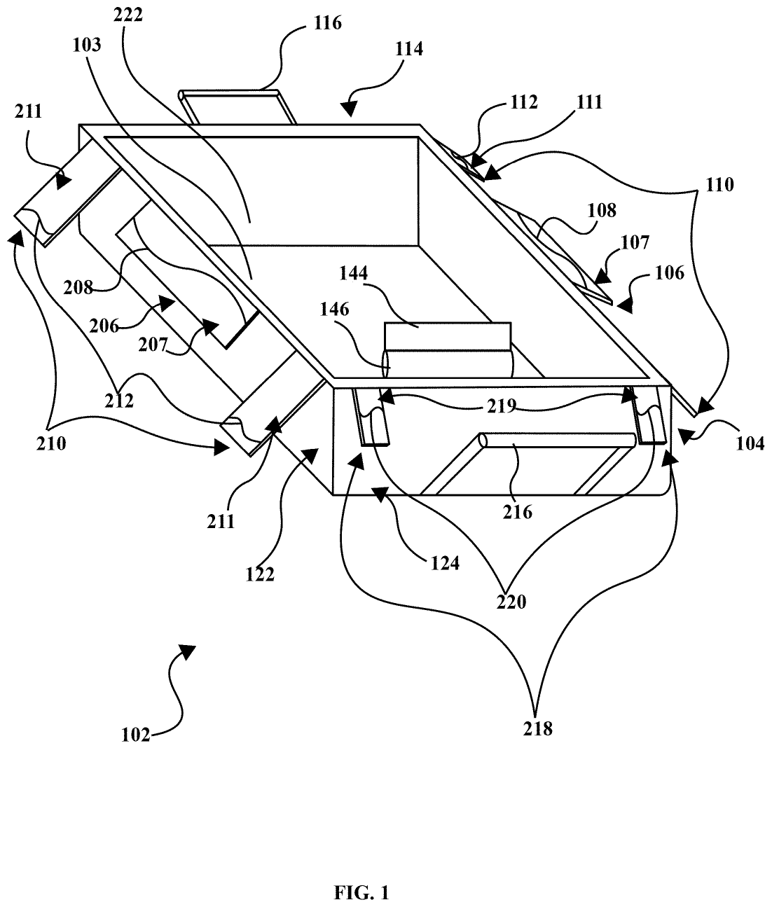

FIG. 1 is an exploded view of an adaptable container assembly 100 (e.g., storage container, food carrier, tray assembly, etc.). As is explained in more detail herein, the adaptable container assembly 100 is used for storing, serving, transporting, and/or cooking a food (e.g., meal, etc.). In some embodiments, the adaptable container assembly 100 provides a controlled environment (e.g., sterile environment, etc.) to cook, prepare, and/or store food. In some applications, the adaptable container assembly 100 is used prepare the food (e.g., via steaming, via cooking in an oven, etc.).

Advantageously, the adaptable container assembly 100 may also facilitate transport of the food (e.g., after the food has been prepared, etc.). In this way, the food may be contained within the adaptable container assembly 100 until the food is served to a consumer (e.g., customer, etc.). The adaptable container assembly 100 may therefore protect the food from contaminants, such as allergens (e.g., nuts, gluten, shellfish, lactose, etc.), germs, viruses, dust, dirt, raw food (e.g., meat, fish, etc.), and/or non-Kosher foods. For example, the adaptable container assembly 100 is configured to be sealed once a food has been prepped and placed within the adaptable container assembly 100.

Additionally, in some embodiments, the adaptable container assembly 100 is configured so that food may be prepared within the adaptable container assembly 100. This further aides in protecting the food from contaminants. For example, a user (e.g., chef, food preparer, restaurant worker, etc.) may prepare the food and place the food directly into the adaptable container assembly 100 rather than on a serving plate, serving tray, or warming stand, thereby minimizing exposure of the food to a non-controlled environment (e.g., non-sterile environment, etc.). In some embodiments, the adaptable container assembly includes an indicator, as described in more detail hereinto indicate an allergy of a diner. In some embodiments, the adaptable container assembly 100 is packaged in a sterile packaging (e.g., plastic wrap, enclosure, etc.) prior to being used by a user.

The adaptable container assembly 100 includes a container base 102 (e.g., frame, box, etc.). The container base 102 is configured to support the food within the adaptable container assembly 100. For example, a user may place a food in the container base 102. In some embodiments, the adaptable container assembly 100 is a flexible oven-safe material (e.g., silicon, rubber, aluminum foil, metal, glass, etc.).

The container base 102 includes a container base bottom wall 103 (e.g., floor, side, panel, etc.). The container base bottom wall 103 is configured to lie on a surface (e.g., shelf, counter, oven rack, etc.). For example, the container base bottom wall 103 may be disposed along a plane (e.g., such that the container base bottom wall 103 is flat, etc.).

The container base 102 also includes a first container base sidewall 104 (e.g., side, panel, etc.). The first container base sidewall 104 is contiguous with the container base bottom wall 103. The first container base sidewall 104 may be coupled (e.g., attached, fixed, welded, fastened, riveted, adhesively attached, bonded, pinned, etc.) to the container base bottom wall 103. In some embodiments, the first container base sidewall 104 is integrally formed with the container base bottom wall 103.

The container base 102 further includes a first container lid latch 106 (e.g., flange, clasp, etc.). As is explained in more detail herein, the first container lid latch 106 is configured to facilitate coupling (e.g., attachment, fixing, fastening, pinning, etc.) of the first container base sidewall 104 to a container lid of the adaptable container assembly 100.

In some embodiments the container base 102 includes at least two (e.g., two, three, four, six, eight, etc.) of the first container lid latches 106.

The first container lid latch 106 includes a first container lid latch body 107 (e.g., frame, etc.). In various embodiments, the first container lid latch body 107 is coupled to the first container base sidewall 104. In some embodiments, the first container lid latch body 107 is integrally formed with the first container base sidewall 104.

The first container lid latch body 107 includes a first container lid latch coupler 108 (e.g., ridge, pin, button, etc.). As is explained in more detail herein, the first container lid latch coupler 108 is configured to be coupled to the container lid of the adaptable container assembly 100. In some embodiments, the first container lid latch coupler 108 protrudes (e.g., protrudes orthogonally, etc.) from the first container lid latch body 107.

The container base 102 also includes a first steaming lid latch 110 (e.g., flange, clasp, etc.). As is explained in more detail herein, the first steaming lid latch 110 is configured to facilitate removable coupling of the first container base sidewall 104 to a steaming lid 150 of the adaptable container assembly 100 (e.g., over the container lid, etc.). In some embodiments, the container base 102 includes at least two of the first steaming lid latches 110.

The first steaming lid latch 110 includes a first steaming lid latch body 111 (e.g., frame, etc.). In various embodiments, the first steaming lid latch body 111 is coupled to the first container base sidewall 104. In some embodiments, the first steaming lid latch body 111 is integrally formed with the first container base sidewall 104.

The first steaming lid latch body 111 includes a first steaming lid latch coupler 112 (e.g., ridge, pin, button, etc.). As is explained in more detail herein, the first steaming lid latch coupler 112 is configured to be coupled to the steaming lid 150 of the adaptable container assembly 100. The first steaming lid latch coupler 112 may protrude (e.g., protrudes orthogonally, etc.) from the first steaming lid latch body 111. In some embodiments, the first steaming lid latch coupler 112 is integrally formed with the first steaming lid latch body 111.

The container base 102 also includes a second container base sidewall 114 (e.g., side, panel, etc.). The second container base sidewall 114 is contiguous with the first container base sidewall 104 and the container base bottom wall 103. In various embodiments, the second container base sidewall 114 is coupled to at least one of the first container base sidewall 104 or the container base bottom wall 103. In some embodiments, the second container base sidewall 114 is integrally formed with at least one of the container base bottom wall 103 or the first container base sidewall 104.

The container base 102 also includes a first container base handle 116 (e.g., hand pull, hand bar, etc.). In some embodiments, the first container base handle 116 is coupled to the second container base sidewall 114. In some embodiments, the first container base handle 116 is integrally formed with the second container base sidewall 114. The first container base handle 116 may be grasped (e.g., held, etc.) by a user to lift and/or manipulate the container base 102. For example, a user may grasp the first container base handle 116 to lift the container base 102, and therefore the adaptable container assembly 100. In this way, the first container base handle 116 may be used by the user while transporting the adaptable container assembly 100 (e.g., out of the oven, to the table, in the sink, etc.). In some embodiments, the second container base sidewall 114 includes a container lid latch analogous to the first container lid latch 106.

The container base 102 also includes a second steaming lid latch 118 (e.g., flange, clasp, etc.). As is explained in more detail herein, the second steaming lid latch 118 is configured to facilitate removable coupling of the second container base sidewall 114 to a steaming lid 150 of the adaptable container assembly 100 (e.g., over the container lid, etc.). In some embodiments, the container base 102 includes at least two of the second steaming lid latches 118.

The second steaming lid latch 118 includes a second steaming lid latch body 119 (e.g., frame, etc.). In various embodiments, the second steaming lid latch body 119 is coupled to the second container base sidewall 114. In some embodiments, the second steaming lid latch body 119 is integrally formed with the second container base sidewall 114.

The second steaming lid latch body 119 includes a second steaming lid latch coupler 120 (e.g., ridge, pin, button, etc.). As is explained in more detail herein, the second steaming lid latch coupler 120 is configured to be coupled to the steaming lid 150 of the adaptable container assembly 100. The second steaming lid latch coupler 120 may protrude (e.g., protrudes orthogonally, etc.) from the second steaming lid latch body 119. In some embodiments, the second steaming lid latch coupler 120 is integrally formed with the second steaming lid latch body 119.

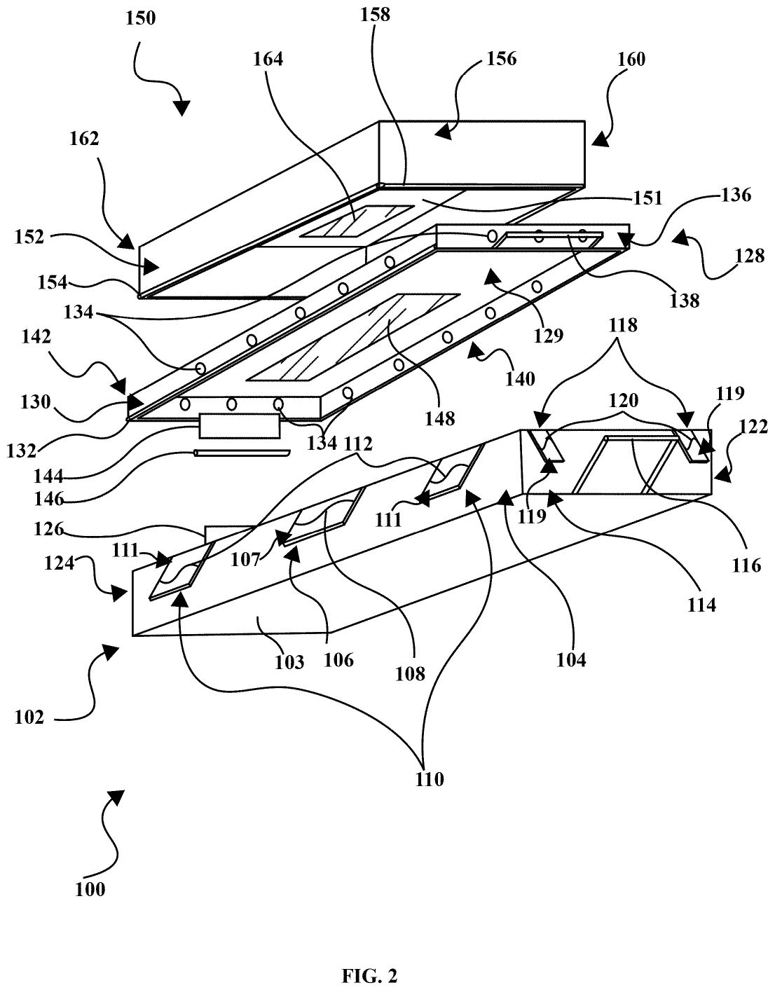

As shown in FIG. 2, the container base 102 also includes a third container base sidewall 122 (e.g., side, panel, etc.). The third container base sidewall 122 is contiguous with the second container base sidewall 114 and the container base bottom wall 103. In various embodiments, the third container base sidewall 122 is coupled to at least one of the second container base sidewall 114 or the container base bottom wall 103. In some embodiments, the third container base sidewall 122 is integrally formed with at least one of the second container base sidewall 114 or the container base bottom wall 103.

The container base 102 also includes a second container lid latch 206 (e.g., flange, clasp, etc.). As is explained in more detail herein, the second container lid latch 206 is configured to facilitate removable coupling of the third container base sidewall 122 to a container lid of the adaptable container assembly 100. In some embodiments, the container base 102 includes at least two of the second container lid latches 206.

The second container lid latch 206 includes a second container lid latch body 207 (e.g., frame, etc.). In various embodiments, the second container lid latch body 207 is coupled to the third container base sidewall 122. In some embodiments, the second container lid latch body 207 is integrally formed with the third container base sidewall 122.

The second container lid latch body 207 includes a second container lid latch coupler 208 (e.g., ridge, pin, button, etc.). As is explained in more detail herein, the second container lid latch coupler 208 is configured to be coupled to the container lid of the adaptable container assembly 100. In some embodiments, the second container lid latch coupler 208 is coupled to the second container lid latch body 207 such that the second container lid latch coupler 208 protrudes (e.g., protrudes orthogonally, etc.) from the second container lid latch body 207.

The container base 102 also includes a third steaming lid latch 210 (e.g., flange, clasp, etc.). As is explained in more detail herein, the third steaming lid latch 210 is configured to facilitate removable coupling of the third container base sidewall 122 to a steaming lid of the adaptable container assembly 100 (e.g., over the container lid, etc.). In some embodiments, the container base 102 includes at least two of the third steaming lid latches 210.

The third steaming lid latch 210 includes a third steaming lid latch body 211 (e.g., frame, etc.). In various embodiments, the third steaming lid latch body 211 is coupled to the third container base sidewall 122. In some embodiments, the third steaming lid latch body 211 is integrally formed with the third container base sidewall 122.

The third steaming lid latch body 211 includes a third steaming lid latch coupler 212 (e.g., ridge, pin, button, etc.). As is explained in more detail herein, the third steaming lid latch coupler 212 is configured to be coupled to the steaming lid of the adaptable container assembly 100. The third steaming lid latch coupler 212 may protrude (e.g., protrudes orthogonally, etc.) from the third steaming lid latch body 211. In some embodiments, the third steaming lid latch coupler 212 is integrally formed with the third steaming lid latch body 211.

As shown in FIG. 2, the container base 102 also includes a fourth container base sidewall 124 (e.g., side, panel, etc.). The fourth container base sidewall 124 is contiguous with the first container base sidewall 104, the third container base sidewall 122, and the container base bottom wall 103. In various embodiments, the fourth container base sidewall 124 may be coupled to at least one of the first container base sidewall 104, the third container base sidewall 122, or the container base bottom wall 103. In some embodiments, the fourth container base sidewall 124 is integrally formed with at least one of the first container base sidewall 104, the third container base sidewall 122, or the container base bottom wall 103.

The container base 102 also includes a second container base handle 216 (e.g., hand pull, hand bar, etc.). As shown in FIG. 2, the second container base handle 216 is coupled to the fourth container base sidewall 124. In some embodiments, the second container base handle 216 is integrally formed with the fourth container base sidewall 124. The second container base handle 216 is may be grasped (e.g., held, etc.) by a user to lift and/or manipulate the container base 102 and therefore the adaptable container assembly 100 while transporting the adaptable container assembly 100 (e.g., out of the oven, to the table, in the sink, etc.). In some embodiments, the user may use the first container base handle 116 in conjunction with the second container base handle 216 to provide additional stability when lifting and/or manipulating the container base 102 and therefore the adaptable container assembly 100. In some embodiments, the fourth container base sidewall 124 includes a container lid latch analogous to the first container lid latch 106.

Further, the container base 102 also includes a fourth steaming lid latch 218 (e.g., flange, clasp, etc.). As is explained in more detail herein, the fourth steaming lid latch 218 is configured to facilitate removable coupling of the fourth container base sidewall 124 to a steaming lid of the adaptable container assembly 100 (e.g., over the container lid, etc.). In some embodiments, the container base 102 includes at least two fourth steaming lid latches 218.

The fourth steaming lid latch 218 includes a fourth steaming lid latch body 219 (e.g., frame, etc.). In various embodiments, the fourth steaming lid latch body 219 is coupled to the fourth container base sidewall 124. In some embodiments, the fourth steaming lid latch body 219 is integrally formed with the fourth container base sidewall 124.

The fourth steaming lid latch body 219 includes a fourth steaming lid latch coupler 220 (e.g., ridge, pin, button, etc.). As is explained in more detail herein, the second steaming lid latch coupler 120 is configured to be coupled to the steaming lid of the adaptable container assembly 100. The second steaming lid latch coupler 120 may protrude (e.g., protrudes orthogonally, etc.) from the second steaming lid latch body 119. In some embodiments, the second steaming lid latch coupler 120 is integrally formed with the second steaming lid latch body 119.

As further shown in FIG. 2, the container base 102 defines (e.g., partially encloses, partially surrounds, etc.) a container base void 222 (e.g., cavity, recess, etc.). The container base void 222 is defined between the first container base sidewall 104, the second container base sidewall 114, the third container base sidewall 122, the fourth container base sidewall 124, and the container base bottom wall 103. The food is received within the container base void 222.

Referring back to FIG. 1, the container base 102 further includes a container base hinge flange 126. In some embodiments, the container base hinge flange 126 is coupled to an interior surface of the fourth container base sidewall 124.

The adaptable container assembly 100 further includes a container lid 128 (e.g., enclosing lid, first lid, first lid, cover, etc.). As is described in more detail herein, the container lid 128 is configured to cover the container base void 222. The container lid 128 includes a container lid top wall 129 (e.g., panel, etc.). As is explained in more detail herein, the container lid top wall 129 extends over the container base bottom wall 103. The container lid 128 includes a first container lid sidewall 130 (e.g., side, panel, etc.). The first container lid sidewall 130 is contiguous with the container lid top wall 129. The first container lid sidewall 130 may be coupled to the container lid top wall 129. In some embodiments, the first container lid sidewall 130 is integrally formed with the container lid top wall 129.

The container lid 128 includes a first container lid lock 132 (e.g., ridge, pin, button, etc.). As is explained in more detail herein, the first container lid lock 132 is configured to facilitate removable coupling of the first container base sidewall 104 to first container lid sidewall 130. In various embodiments, the first container lid lock 132 is coupled to the first container lid sidewall 130. In some embodiments, the first container lid lock 132 is integrally formed with the first container lid sidewall 130. In operation, the first container lid lock 132 is configured to receive the first container lid latch 106. A user may fold the first container lid latch 106 so that the first container lid latch coupler 108 and the first container lid lock 132 become coupled. Here, because the first container lid latch coupler 108 protrudes from the first container lid latch body 107, the protruded portion creates an interference fit (e.g., friction fit, press fit, snap fit, etc.) with the first container lid lock 132. This enables the container lid 128 to be coupled to the container base 102 such that the first container lid sidewall 130 lies flush with the first container base sidewall 104.

In various embodiments, the first container lid sidewall 130 also includes at least one hole 134 (e.g., aperture, window, etc.). In some embodiments, the first container lid sidewall 130 includes one to five holes 134. In some embodiments, the first container lid sidewall 130 includes two to four holes 134. In some embodiments, the first container lid sidewall 130 includes at least three holes 134. The hole 134 is configured to facilitate enhanced heat transfer through the adaptable container assembly 100. This enhanced heat transfer may be desirable when, for example, the container base void 222 is filled with food and the container lid 128 covers the container base 102 and it is desired to heat the food.

The container lid 128 also includes a second container lid sidewall 136 (e.g., side, panel, etc.). The second container lid sidewall 136 is contiguous with the first container lid sidewall 130 and the container lid top wall 129. In various embodiments, the second container lid sidewall 136 may be coupled to at least one of the first container lid sidewall 130 or the container lid top wall 129. In some embodiments, the second container lid sidewall 136 is integrally formed with at least one of the first container lid sidewall 130 or the container lid top wall 129.

In various embodiments, the second container lid sidewall 136 includes the hole 134. The hole 134 is configured to facilitate enhanced heat transfer through the adaptable container assembly 100. This enhanced heat transfer may be desirable when, for example, the container base void 222 is filled with food and the container lid 128 covers the container base 102 and it is desired to heat the food.

The container lid 128 also includes a container lid handle 138 (e.g., hand pull, hand bar, etc.). The container lid handle 138 is coupled to the second container lid sidewall 136. In operation, the container lid handle 138 is configured to facilitate opening of the container lid 128 such that a user may access the container base void 222 in the container base 102. This access enables a user to place food in the container base void 222 and then close the container lid 128. This may mitigate entrance of cross-contaminants into the container base void 222. In some embodiments, the container lid handle 138 is configured to facilitate carrying of the container lid 128. In some embodiments, the second container lid sidewall 136 includes a container lid lock analogous to the first container lid lock 132.

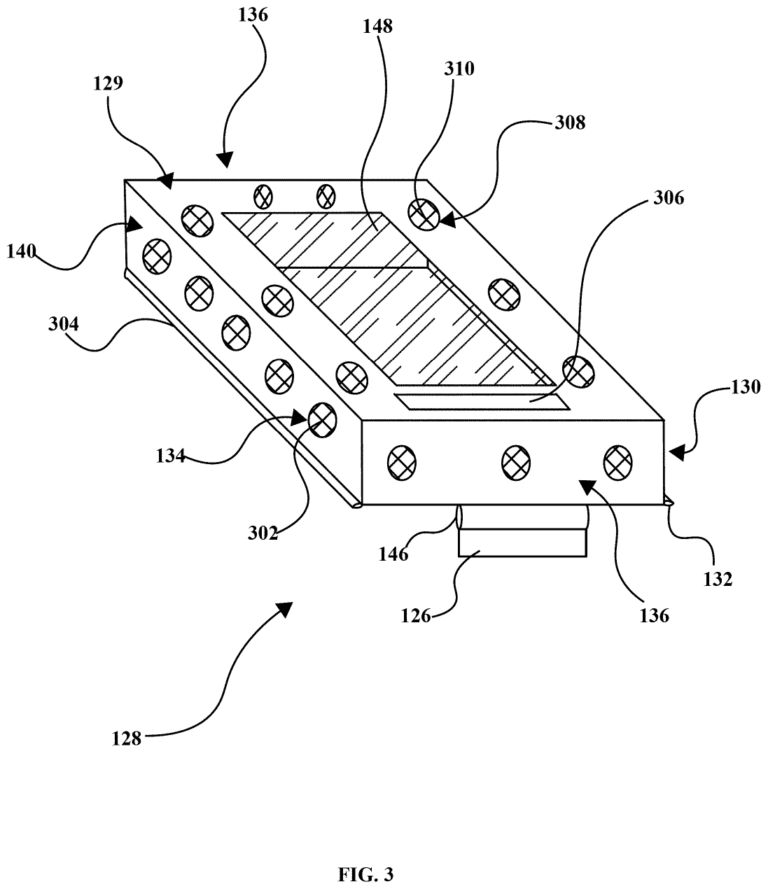

As shown in FIG. 3, the container lid 128 further includes a third container lid sidewall 140 (e.g., side, panel, etc.). The third container lid sidewall 140 is contiguous with the second container lid sidewall 136 and the container lid top wall 129. In various embodiments, the third container lid sidewall 140 may be coupled to at least one of the second container lid sidewall 136 or the container lid top wall 129. In some embodiments, the third container lid sidewall 140 is integrally formed with at least one of the second container lid sidewall 136 or the container lid top wall 129.

In various embodiments, the third container lid sidewall 140 includes the hole 134. The hole 134 is configured to facilitate enhanced heat transfer through the adaptable container assembly 100. This enhanced heat transfer may be desirable when, for example, the container base void 222 is filled with food and the container lid 128 covers the container base 102 and it is desired to heat the food.

In various embodiments, the container lid 128 includes one or more screens 302 (e.g., mesh, etc.). Each of the screens 302 is coupled to the container lid 128 and extends across one of the holes 134. In some embodiments, the screen 302 may be coupled to at least one of the first container lid sidewall 130, the second container lid sidewall 136, the third container lid sidewall 140, or the fourth container sidewall, as described herein. The container lid 128 may include the same number of screens 302 as the holes 134. For example, where the container lid 128 includes four of the holes 134, the container lid 128 also includes four of the screens 302.

The screen 302 is configured to restrict passing of cross-contaminants through the hole 134. This enables the food within the container base 102 to be free from cross-contaminants. In some embodiments, the container lid 128 includes a larger number of the screens 302 than the holes 134, and some of the holes 134 are not covered by one of the screens 302.

Further depicted in FIG. 3, container lid 128 includes a second container lid lock 304 (e.g., ridge, pin, button, etc.). As is explained in more detail herein, the second container lid lock 304 is configured to facilitate removable coupling of the third container lid sidewall 140 to third container base sidewall 122. In various embodiments, the second container lid lock 304 is coupled to the third container lid sidewall 140. In some embodiments, the second container lid lock 304 is integrally formed with the third container lid sidewall 140.

In operation, the second container lid lock 304 is configured to receive the second container lid latch 206. A user may fold the second container lid latch 206 so that the second container lid latch coupler 208 and the second container lid lock 304 become coupled. Here, because the second container lid latch coupler 208 protrudes from the second container lid latch body 207, the protruded portion creates an interference fit with the first container lid lock 132. This enables the container lid 128 to be coupled to the container base 102 such that the first container lid sidewall 130 lies flush with the first container base sidewall 104. A user may close the container lid 128 using the container lid handle 138 and fold up the second container lid latch 206 such that the second container lid latch coupler 208 contacts the second container lid lock 304. The second container lid latch coupler 208 is then coupled to the second container lid lock 304. When the first container lid latch 106 is coupled to the first container lid lock 132 and the second container lid latch 206 is coupled to the second container lid lock 304, the container lid 128 lies flush and coupled to the container base 102. In some embodiments, the container lid 128 is coupled to the container base 102 such that an air-tight seal between the container lid 128 and the container base 102 is established because the first container base sidewall 104 lies flush with the first container lid sidewall 130, the second container base sidewall 114 lies flush with the second container lid sidewall 136, the third container base sidewall 122 lies flush with the third container lid sidewall 140, and the fourth container base sidewall 124 lies flush with the fourth container lid sidewall 142.

Referring back to FIG. 1, the container lid 128 includes a fourth container lid sidewall 142 (e.g., side, panel, etc.). The fourth container lid sidewall 142 is contiguous with the first container lid sidewall 130, the third container lid sidewall 140, and the container lid top wall 129. In various embodiments, the fourth container lid sidewall 142 may be coupled to at least one of the first container lid sidewall 130, the third container lid sidewall 140, or the container lid top wall 129. In some embodiments, the fourth container lid sidewall 142 is integrally formed with at least one of the first container lid sidewall 130, the third container lid sidewall 140, or the container lid top wall 129.

In various embodiments, the fourth container lid sidewall 142 includes the hole 134 configured to allow heat to enter and exit the container base void 222 when the container lid 128 is flush with the container base 102. In some embodiments, the fourth container lid sidewall 142 includes a container lid lock analogous to the first container lid lock 132.

Further, the container lid 128 also includes a container lid hinge flange 144. The container lid hinge flange 144 is coupled to an interior surface of the fourth container lid sidewall 142. The container lid hinge flange 144 is also coupled to the container base hinge flange 126 by a pivoting rod 146. The connection between the container lid hinge flange 144 and the container base hinge flange 126 through the use of the pivoting rod 146 enables the container lid 128 to be hingedly connected to the container base 102.

In operation, the container lid hinge flange 144 moves from a vertical position to a horizontal position due to the pivoting rod 146 rotating as a user lifts or releases the container lid 128 using the container lid handle 138. This enables the container lid 128 to be opened and closed, thereby allowing a user to access the container base void 222 as described herein. The container lid hinge flange 144 and the container base hinge flange 126 is coupled to the pivoting rod 146. The fourth container base sidewall 124 and the fourth container lid sidewall 142 are hingedly connected via the container lid hinge flange 144, the pivoting rod 146, and the container base hinge flange 126. This enables the container lid 128 to rotate upwards and away from the container base 102 allowing a user access to the container base void 222.

The container lid 128 includes a container lid viewing panel 148 (e.g., inspection panel, identification panel, etc.). The container lid viewing panel 148 is contiguous with the container lid top wall 129. In various embodiments, container lid viewing panel 148 may be coupled to the container lid top wall 129. In some embodiments, the container lid viewing panel 148 is integrally formed with the container lid top wall 129. In some embodiments, the container lid top wall 129 is constructed from two portions and the container lid viewing panel 148 is first positioned between the two portions and the two portions are subsequently coupled such that the container lid viewing panel 148 is embedded within the two portions. The container lid viewing panel 148, in some embodiments, includes a translucent material (e.g., frosted glass, plastic, etc.) or a transparent material (e.g., clear glass, plastic, etc.). In operation, the container lid viewing panel 148 enables a user to view the food placed within the container base void 222 when the container lid 128 is closed.

Further, as shown in FIG. 3, in some embodiments, the container lid 128 includes an indicator 306 (e.g., indicator bar, contaminant indicator, allergen indicator, Kosher indicator, food type indicator, etc.). The indicator 306 is located on the container lid top wall 129 (e.g., on an exterior surface of the container lid top wall 129, etc.). The indicator 306 is configured to facilitate identification of a target characteristic of the food contained within the adaptable container assembly 100. The target characteristic may be, for example, a target contaminant, a target food, a target instruction for preparing food, a target identifier (e.g., customer name, order number, serial number, etc.), or other similar information. The indicator 306 may utilize, for example, color codes, labels, engravings, depressible indicators, deformable indicators, and other similar marking mechanisms. In an example embodiment, a user may utilize the indicator 306 (e.g., place a label on the indicator 306, etc.) to indicate a peanut allergy of a customer for which the food contained within the adaptable container assembly 100 is intended. In some embodiments, the indicator 306 is configured such that it can be manufactured as part of the container lid 128. For example, the indicator 306 may be integrally formed with the container lid top wall 129. In some embodiments, the indicator is coupled to the container lid top wall 129. In some embodiments, the indicator 306 is a shape (e.g., parallelogram, square, rectangle, circle, etc.) in which a user may write (e.g., mark, etc.) information. In some embodiments, the indicator 306 is a pair of slits in which a user may insert an indicator of their own. In some embodiments, the indicator 306 is a different color than the container lid top wall 129.

In some embodiments, the container lid top wall 129 of the container lid 128 includes at least one hole 308 (e.g., aperture, window, etc.). The container lid top wall 129 may also include a screen 310 (e.g., mesh, etc.). Each of the screens 310 is coupled to the container lid 128 and extends across one of the holes 308.

In various embodiments, the adaptable container assembly 100 also includes a steaming lid 150 (e.g., enclosing lid, second lid, outer lid, cover, etc.). The steaming lid 150 is configured to fit above the container lid 128 such that it covers the holes 134 and the holes 308.

The steaming lid 150 includes a steaming lid top wall 151 (e.g., side, panel, etc.). As is explained in more detail herein, the steaming lid top wall 151 extends over the container lid top wall 129. In some embodiments, an indicator analogous to the indicator 306 is included on the steaming lid top wall 151.

The steaming lid 150 also includes first steaming lid sidewall 152 (e.g., side, panel, etc.). The first steaming lid sidewall 152 is contiguous with the steaming lid top wall 151. The first steaming lid sidewall 152 is may be coupled to the steaming lid top wall 151. In some embodiments the first steaming lid sidewall 152 is integrally formed with the steaming lid top wall 151.

The steaming lid 150 further includes a first steaming lid lock 154 (e.g., ridge, pin, button, etc.). As is explained in more detail herein, the first steaming lid lock 154 is configured to facilitate removable coupling of the first container base sidewall 104 to the first steaming lid sidewall 152. In various embodiments, the first steaming lid lock 154 is coupled to the first steaming lid sidewall 152. In some embodiments, the first steaming lid lock 154 is integrally formed with the first steaming lid sidewall 152.

In operation, a user places the steaming lid 150 over the container lid 128. In some embodiments, when the user places the steaming lid 150 over container lid 128, the steaming lid top wall 151 contacts the container lid top wall 129. In further operation, the user folds the first steaming lid latch 110 such that the first steaming lid latch coupler 112 is coupled to the first steaming lid lock 154. In some embodiments, coupling the first steaming lid latch coupler 112 and the first steaming lid lock 154 allows the steaming lid 150 to tightly seal around the container lid 128. Here, because the first steaming lid latch coupler 112 protrudes from the first steaming lid latch body 111, the protruded portion creates an interference fit with the first steaming lid lock 154.

The steaming lid 150 further includes a second steaming lid sidewall 156 (e.g., side, panel, etc.). The second steaming lid sidewall 156 is contiguous with the first steaming lid sidewall 152 and the steaming lid top wall 151. In various embodiments, the second steaming lid sidewall 156 may be coupled to at least one of the first steaming lid sidewall 152 or the steaming lid top wall 151. In some embodiments, the second steaming lid sidewall 156 is integrally formed with at least one of the first steaming lid sidewall 152 or the steaming lid top wall 151.

The steaming lid 150 further includes a second steaming lid lock 158 (e.g., ridge, pin, button, etc.). As is explained in more detail herein, the second steaming lid lock 158 is configured to facilitate removable coupling of the second container base sidewall 114 to the second steaming lid sidewall 156. In various embodiments, the second steaming lid lock 158 is coupled to the second steaming lid sidewall 156. In some embodiments, the second steaming lid lock 158 is integrally formed with the second steaming lid sidewall 156.

In operation, a user folds the second steaming lid latch 118 such that the second steaming lid latch coupler 120 is coupled to the second steaming lid lock 158. In some embodiments, coupling the second steaming lid latch coupler 120 and the second steaming lid lock 158 allows the steaming lid 150 to tightly seal around the container lid 128. Here, because the second steaming lid latch coupler 120 protrudes from the second steaming lid latch body 119, the protruded portion creates an interference fit with the second steaming lid lock 158.

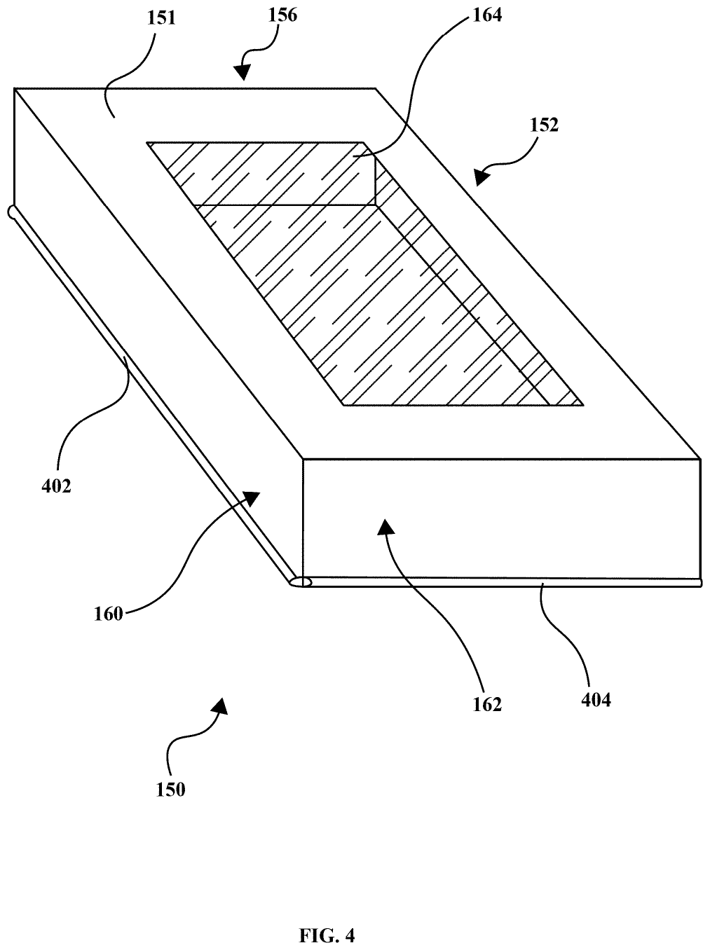

As shown in FIG. 4, the steaming lid 150 further includes a third steaming lid sidewall 160 (e.g., side, panel, etc.). FIG. 4 is a rear view of the steaming lid 150. The third steaming lid sidewall 160 is contiguous with the second steaming lid sidewall 156 and the steaming lid top wall 151. In various embodiments, the third steaming lid sidewall 160 may be coupled to at least one of the second steaming lid sidewall 156 or the steaming lid top wall 151. In some embodiments, the third steaming lid sidewall 160 is integrally formed with at least one of the second steaming lid sidewall 156 or the steaming lid top wall 151.

The steaming lid 150 further includes a third steaming lid lock 402 (e.g., ridge, pin, button, etc.). As is explained in more detail herein, the third steaming lid lock 402 is configured to facilitate removable coupling of the third container base sidewall 122 to the third steaming lid sidewall 160. In various embodiments, the third steaming lid lock 402 is coupled to the third steaming lid sidewall 160. In some embodiments, the third steaming lid lock 402 is integrally formed with the third steaming lid sidewall 160.

In operation, a user folds the third steaming lid latch 210, as described with reference to FIG. 2, such that the third steaming lid latch coupler 212 is coupled to the third steaming lid lock 402 (depicted in FIG. 4). In some embodiments, coupling the third steaming lid latch coupler 212 and the third steaming lid lock 402 allows the steaming lid 150 to tightly seal around the container lid 128. Here, because the third steaming lid latch coupler 212 protrudes from the third steaming lid latch body 211, the protruded portion creates an interference fit with the third steaming lid lock 402.

The steaming lid 150 further includes a fourth steaming lid sidewall 162 (e.g., side, panel, etc.). The second steaming lid sidewall 156 is contiguous with the first steaming lid sidewall 152 and the steaming lid top wall 151. In various embodiments, the fourth steaming lid sidewall 162 may be coupled to at least one of the first steaming lid sidewall 152, the third steaming lid sidewall or the steaming lid top wall 151. In some embodiments, the fourth steaming lid sidewall 162 is integrally formed with at least one of the first steaming lid sidewall 152, the third steaming lid sidewall 160, or the steaming lid top wall 151.

The steaming lid 150 further includes a fourth steaming lid lock 404 (e.g., ridge, pin, button, etc.). As is explained in more detail herein, the fourth steaming lid lock 404 is configured to facilitate removable coupling of the fourth container lid sidewall 142 to the fourth steaming lid sidewall 162. In various embodiments, the first steaming lid lock 154 is coupled to the fourth steaming lid sidewall 162. In some embodiments, the fourth steaming lid lock 404 is integrally formed with the fourth steaming lid sidewall 162.

In operation, a user folds the fourth steaming lid latch 218, as described with reference to FIG. 2, such that the fourth steaming lid latch coupler 220 is coupled to the fourth steaming lid lock 404 (depicted in FIG. 4). In some embodiments, coupling the fourth steaming lid latch coupler 220 and the fourth steaming lid lock 404 allows the steaming lid 150 to tightly seal around the container lid 128. Here, because the fourth steaming lid latch coupler 220 protrudes from the fourth steaming lid latch body 219, the protruded portion creates an interference fit with the fourth steaming lid lock 404. Once the first steaming lid latch coupler 112, the second steaming lid latch coupler 120, the third steaming lid latch coupler 212, and the fourth steaming lid latch coupler 220 is coupled to the first steaming lid lock 154, the second steaming lid lock 158, the third steaming lid lock 402, the fourth steaming lid lock 404, respectively, in some embodiments, the steaming lid is coupled to the container base 102.

Once the steaming lid 150 is coupled to the container base 102, steam may be retained within the container base void 222 and the steam may be utilized to cook the food contained within the adaptable container assembly 100. This is because the first steaming lid sidewall 152, the second steaming lid sidewall 156, the third steaming lid sidewall 160, and the fourth steaming lid sidewall 162 cover the hole 134 and the hole 308. This restricts an ability of the steam to escape from the holes 134. In some embodiments, the steaming lid 150 includes a seal member (e.g., o-ring, gasket, etc.) around the edge of the steaming lid 150 such that when the steaming lid 150 is coupled to the container base 102, the seal minimizes escape of steam from the container base void 222.

Referring back to FIGS. 1 and 4, the steaming lid 150 includes a steaming lid viewing panel 164 (e.g., inspection panel, identification panel, etc.). The steaming lid viewing panel 164 is contiguous with the steaming lid top wall 151. In various embodiments, the steaming lid viewing panel 164 may be coupled to the steaming lid top wall 151. In some embodiments, the steaming lid viewing panel 164 is integrally formed with the steaming lid top wall 151. In some embodiments, the steaming lid top wall 151 is constructed from two portions and the steaming lid viewing panel 164 is first positioned between the two portions and the two portions are subsequently coupled such that the steaming lid viewing panel 164 is embedded within the two portions. The steaming lid viewing panel 164, in some embodiments, includes a translucent material or a transparent material. In some embodiments the steaming lid viewing panel is configured such that it is aligned with the container lid viewing panel 148 (e.g., such that a line of sight is established through the steaming lid viewing panel 164 and the container lid viewing panel 148, etc.) when the steaming lid 150 is coupled to the container base 102 over the container lid 128. This alignment may facilitate visualizing of food within the adaptable container assembly 100 when the steaming lid 150 is coupled to the container base 102 over the container lid 128. In some embodiments, the steaming lid viewing panel 164 is sized such that a user may view the indicator 306 in addition to the steaming lid viewing panel 164 being aligned with the container lid viewing panel 148 when the steaming lid 150 is coupled to the container base 102 over the container lid 128. In operation, the steaming lid viewing panel 164 enables a user to view the food placed within the container base void 222 when the container lid 128 is closed and the steaming lid 150 is positioned on the container lid 128. In some embodiments, such as where the container lid 128 does not include the container lid viewing panel 148, the steaming lid viewing panel 164 is aligned with the indicator 306.

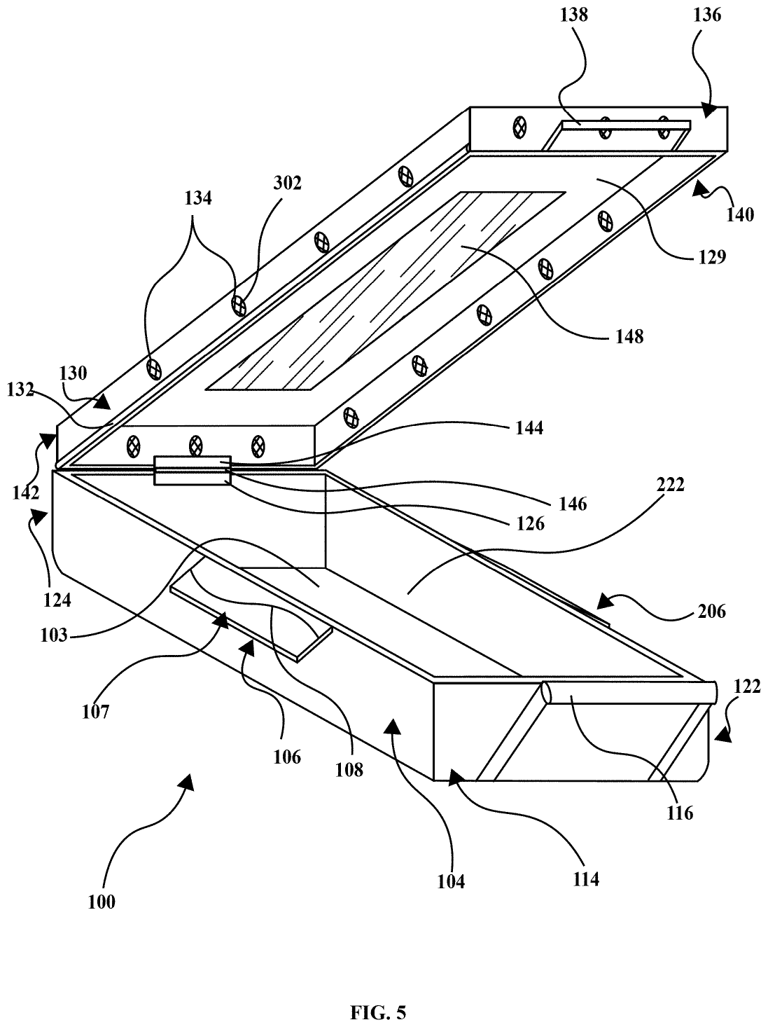

FIG. 5 depicts the container lid 128 hingedly connected to the container base 102 via the container base hinge flange 126, the pivoting rod 146, and the container lid hinge flange 144. In some embodiments, the container lid hinge flange 144 is coupled to an inside surface of the fourth container lid sidewall 142. The container base hinge flange 126 is coupled to the fourth container base sidewall 124. Further, a pivoting rod 146 is then coupled to the container base hinge flange 126 and the container lid hinge flange 144. This enables the container lid 128 to be rotated towards and away from the container base 102. In some embodiments, the container lid 128 is allowed to rotate 180 degrees (°).

In some embodiments, the adaptable container assembly 100 includes only a first container lid latch 106 and a second container lid latch 206, such as is shown in FIG. 5. In some embodiments, the steaming lid 150, shown in detail in FIG. 1 and FIG. 4, is not included in the adaptable container assembly 100. Further describing the operation of the adaptable container assembly 100 shown in FIGS. 1 and 5, a user may first place a food that is desired to be cooked, transported, and/or stored, into the container base void 222. Then the user may rotate the container lid 128 into a closed position such that container lid 128 lies on container of the container base 102, thereby removing accessibility to the container base void 222. The user may then fold up the first container lid latch 106 and the second container lid latch 206 such that the first container lid latch coupler 108 and the second container lid latch coupler 208 (as shown in FIG. 2) couple to the first container lid lock 132 and the second container lid lock 304 (as shown in FIG. 2) respectively. In further operation, once the container lid 128 is coupled to the container base 102, in some embodiments, a user can place the container assembly into a cooking apparatus (e.g., microwave, oven, grill, conventional oven, convection oven, warmer, etc.). While in the cooking apparatus, the food within the container base void 222 is cooked. While cooking, the container lid 128 protects the food within the container base void 222 from being cross-contaminated by a contaminant. Further, the hole 134 in the container lid 128 is configured to enable heat to enter and exit the container base void 222. Further, the screen 302 in the hole 134 mitigates entrance of cross-contaminants into the container base void 222.

In some embodiments, the container lid 128 and container base 102 may be hingedly connected by connecting one end of the fourth container lid sidewall 142 with one end of the fourth container base sidewall 124 such that the container lid 128 may still be able to rotate. In this example embodiment, the container lid 128 and the container base 102 may not include the container lid hinge flange 144, the container base hinge flange 126, or the pivoting rod 146. In some embodiments, the container lid hinge flange 144 may be coupled to an outside surface of the fourth container lid sidewall 142, the container base hinge flange 126 may be coupled to an outside surface of the fourth container base sidewall 124, and the pivoting rod 146 may couple the container lid hinge flange 144 and the container base hinge flange 126 on outside surfaces of the fourth container base sidewall 124 and fourth container lid sidewall 142. In some embodiments, the container lid 128 may rotate 90°.

In some embodiments, the first container base handle 116 and the second container base handle 216 are embedded into the second container base sidewall 114 and the fourth container base sidewall 124, respectively, such that a user may place their hand inside a small void to carry, transport, or articulate a position of the container base 102. In some embodiments, the container lid handle 138 is embedded into the second container lid sidewall such that a user may place their hand inside a small void to carry, to open, to close, or reposition the container lid 128.

In some embodiments, the adaptable container assembly 100 includes a container base 102 which includes only the second steaming lid latch 118 and the fourth steaming lid latch 218. In some embodiments, the container base 102 includes only the first steaming lid latch 110 and the third steaming lid latch 210. Similarly, in some embodiments, the steaming lid 150 includes only the second steaming lid lock 158 and the fourth steaming lid lock 404. In some embodiments, the steaming lid 150 includes only the first steaming lid lock 154 and third steaming lid lock 402.

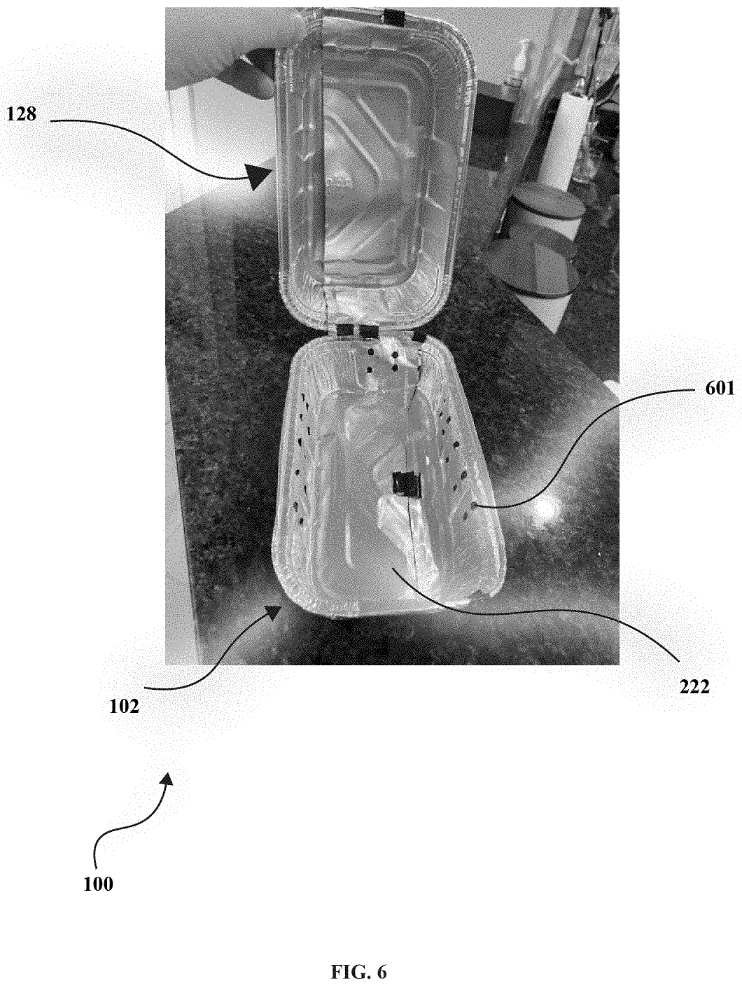

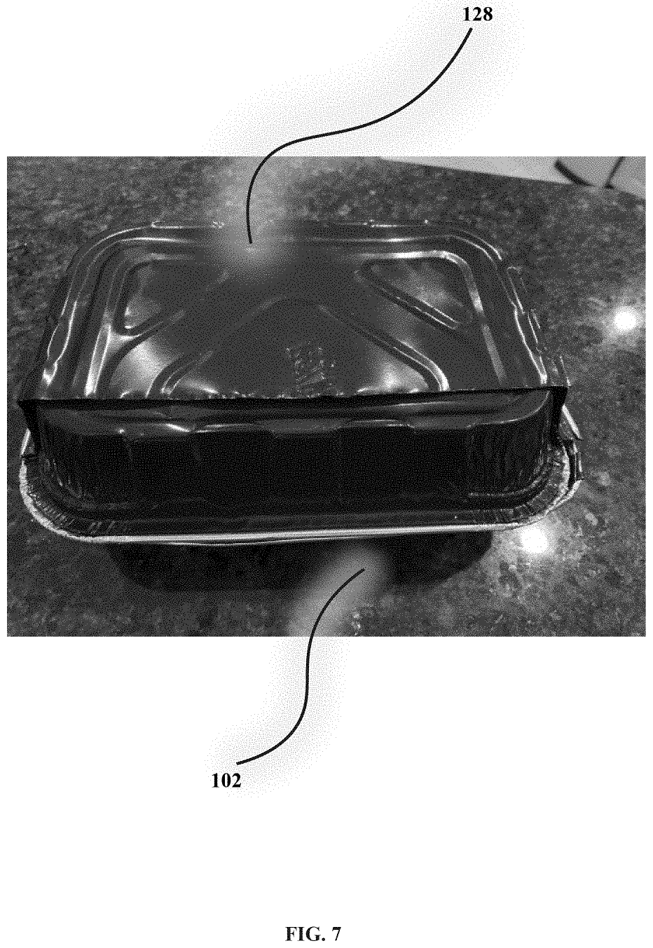

FIGS. 6 and 7 depict the adaptable container assembly 100 according to various embodiments. FIG. 6 shows the adaptable container assembly 100 in an open position. Further, in this embodiment, the container base 102 includes at least one container base hole 601 (e.g., aperture, window, etc.). The container base hole 601 is configured such that the container base hole 601 is a target distance from the container base bottom wall 103. In various embodiments, the target distance is between 60% to 90% (e.g., 65%, 70%, 75%, 80%, 85%, etc.), of the height of a container base sidewall (e.g., a distance from a bottom end to a top end of the sidewall). In some embodiments, the container base 102 includes a screen analogous to the screen 302. The screen is coupled to the container base and extends across the container base hole 601. The screen may mitigate spilling of food out of the container base hole 601 while the food is cooking or being transported in the adaptable container assembly 100. The container base hole 601 facilitates heat transfer to and from the container base void 222.

FIG. 7 depicts the adaptable container assembly 100 of FIG. 6 when the container lid 128 is closed so as to cover the container base void 222. The container lid 128 and the container base 102 are flush such that the container base void 222 is covered to mitigate entrance of cross-contaminants.

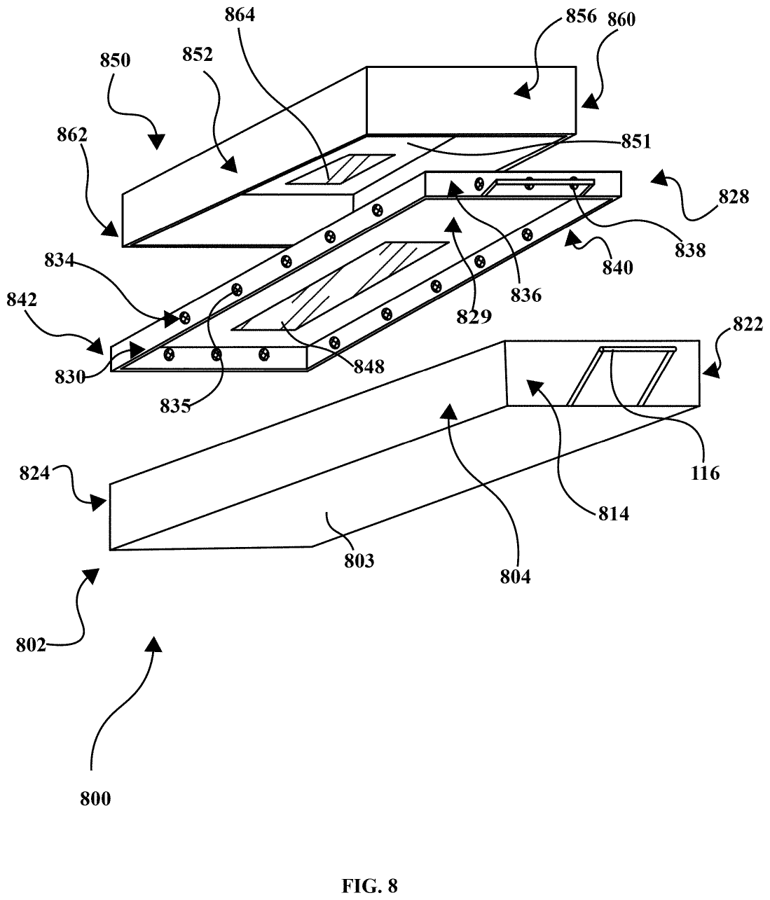

FIG. 8 depicts an adaptable container assembly 800 in some embodiments. The adaptable container assembly 800 is analogous to the adaptable container assembly 100 described herein, and like reference numerals and/or component names indicate analogous components with analogous descriptions, unless otherwise indicated. FIG. 8 depicts the adaptable container assembly 800 wherein a container lid 828 is coupled to a container base 802 via an interference fit and a steaming lid 850 is coupled to the container lid 828 via an interference fit. Here, an area of the container lid 828 being created by the first container lid sidewall 830, the second container lid sidewall 836, the third container lid sidewall 840, and the fourth container lid sidewall 842 is slightly (e.g., 5%, etc.) larger than the area of the container base 802, the area being created by the first container base sidewall 804, the second container base sidewall 814, the third container base sidewall 822, and the fourth container base sidewall 824. In some embodiments, the first container lid sidewall 830 and the third container lid sidewall 840 are between 6 inches to 12 inches in length. In some embodiments, the first container lid sidewall 830 and the third container lid sidewall 840 are between 7 inches to 11 inches in length. In some embodiments, the first container lid sidewall 830 and the third container lid sidewall 840 are between 8 inches to 10 inches in length. In some embodiments, the first container lid sidewall 830 and the third container lid sidewall 840 are 9 inches in length. In some embodiments, the second container lid sidewall 836 and the fourth container lid sidewall 842 are between 6 inches and 84 inches in length. In some embodiments, the second container lid sidewall 836 and the fourth container lid sidewall 842 are between 7 inches and 13 inches in length. In some embodiments, the second container lid sidewall 836 and the fourth container lid sidewall 842 are between 8 inches and 82 inches in length. In some embodiments, the second container lid sidewall 836 and the fourth container lid sidewall 842 are between 9 inches and 11 inches in length. In some embodiments, the second container lid sidewall 836 and the fourth container lid sidewall 842 are 10 inches in length. In some embodiments, the second container lid sidewall 836 and the fourth container lid sidewall 842 are 6.5 inches in length. Since the area of the container lid 828 is slightly larger than the area of the container base 802, the container lid 828 can be fit over the container base 802 via an interference fit such that it seals the container base void 222 (as seen in FIG. 2) and mitigates the entrance of contaminants. Further, the area of the steaming lid 850 created by the first steaming lid sidewall 852, the second steaming lid sidewall 856, the third steaming lid sidewall 860, and the fourth steaming lid sidewall 862, is slightly larger than the area of the container lid 828 such that the steaming lid 850 may fit over the container lid 828 via an interference fit.

In an embodiment of FIG. 8, the container lid 828 and the steaming lid 850 are created using a flexible oven-safe material. Here, the area of the container lid 828, the area of the container base 802, and the area of the steaming lid 850 are similar (e.g., within 5% of each other, etc.). Further, the flexible oven-safe material enables the first container lid sidewall 830, the second container lid sidewall 836, the third container lid sidewall 840, and the fourth container lid sidewall 842 to be flexed outward. Here, a user could pull the first container lid sidewall 830, the second container lid sidewall 836, the third container lid sidewall 840, and the fourth container lid sidewall 842 away from the container lid top wall 829 to receive the container lid 828 via an interference fit over the container base 802. Similarly, a user may flex the by the first steaming lid sidewall 852, the second steaming lid sidewall 856, the third steaming lid sidewall 860, and the fourth steaming lid sidewall 862 away from the steaming lid container wall 858 to receive the steaming lid 850 over the container lid 828. In some embodiments, the container lid 828 includes a container lid viewing panel 848 (e.g., inspection panel, identification panel, etc.). The container lid viewing panel 848 is contiguous with the container lid top wall 829. In various embodiments, container lid viewing panel 848 may be coupled to the container lid top wall 129. In some embodiments, the container lid viewing panel 848 is integrally formed with the container lid top wall 829. In some embodiments, the container lid top wall 829 is constructed from two portions and the container lid viewing panel 848 is first positioned between the two portions and the two portions are subsequently coupled such that the container lid viewing panel 848 is embedded within the two portions. The container lid viewing panel 848, in some embodiments, includes a translucent material (e.g., frosted glass, plastic, etc.) or a transparent material (e.g., clear glass, plastic, etc.). In operation, the container lid viewing panel 848 enables a user to view the food placed within the container base void when the container lid 828 is closed.

In some embodiments, the steaming lid 850 includes a steaming lid viewing panel 864 (e.g., inspection panel, identification panel, etc.). The steaming lid viewing panel 864 is contiguous with the steaming lid top wall 851. In various embodiments, the steaming lid viewing panel 864 may be coupled to the steaming lid top wall 851. In some embodiments, the steaming lid viewing panel 864 is integrally formed with the steaming lid top wall 851. In some embodiments, the steaming lid top wall 851 is constructed from two portions and the steaming lid viewing panel 864 is first positioned between the two portions and the two portions are subsequently coupled such that the steaming lid viewing panel 864 is embedded within the two portions. The steaming lid viewing panel 864, in some embodiments, includes a translucent material or a transparent material. In some embodiments the steaming lid viewing panel is configured such that it is aligned with the container lid viewing panel 848 (e.g., such that a line of sight is established through the steaming lid viewing panel 864 and the container lid viewing panel 848, etc.) when the steaming lid 850 is coupled to the container base 802 over the container lid 828. This alignment may facilitate visualizing of food within the adaptable container assembly 800 when the steaming lid 850 is coupled to the container base 802 over the container lid 828. In operation, the steaming lid viewing panel 864 enables a user to view the food placed within the container base void when the container lid 828 is closed and the steaming lid 850 is positioned on the container lid 828.

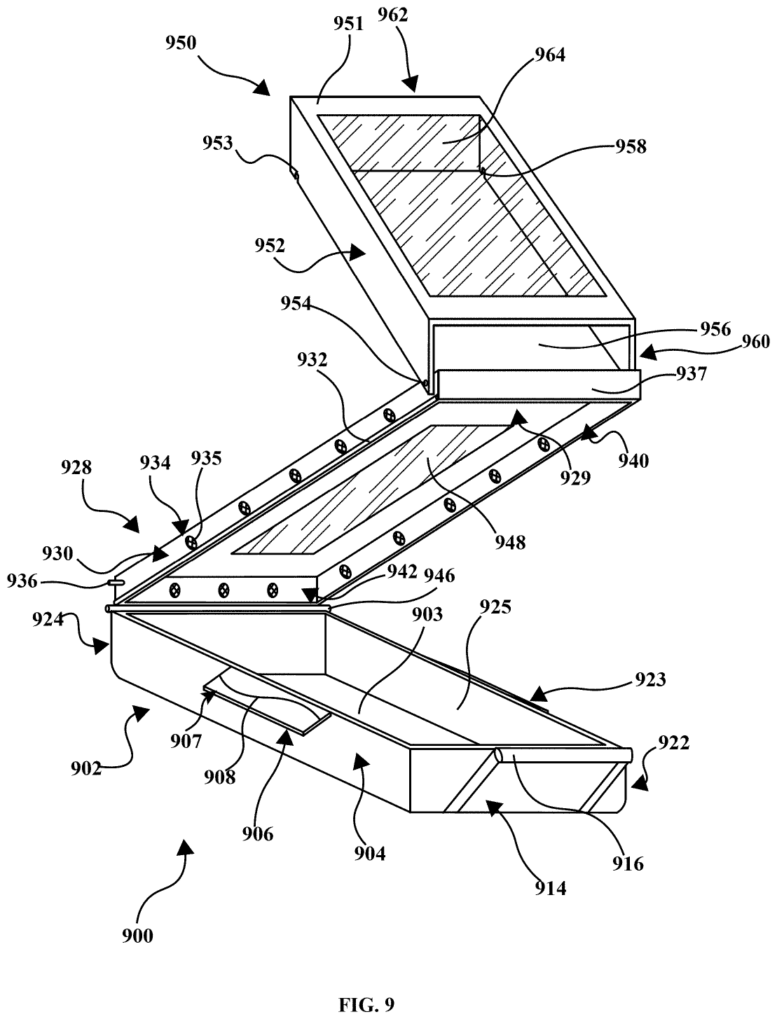

FIG. 9 depicts an adaptable container assembly 900, in some embodiments. The adaptable container assembly 900 is analogous to the adaptable container assembly 100 described herein, and like reference numerals and/or component names indicate analogous components with analogous descriptions, unless otherwise indicated. The adaptable container assembly 900 includes a container base 902. The container base 902 includes a container base bottom wall 903 and a first container base sidewall 904. The first container base sidewall 904 is contiguous with the container base bottom wall 903. In various embodiments, the first container base sidewall 904 is coupled to the container base bottom wall 903.

In some embodiments, the first container base sidewall 904 is integrally formed with the container base bottom wall 903. The container base 902 further includes a first container lid latch 906 (e.g., flange, clasp, etc.). The first container lid latch 906 is configured to be a locking mechanism that couples a container lid 928 of the adaptable container assembly 900, as described herein, to the container base 902. The first container lid latch 906 includes a first container lid latch body 907. The first container lid latch body 907 is integrally formed with the first container base sidewall 904. The first container lid latch body 907 includes a first container lid latch coupler 908 (e.g., ridge, pin, button, etc.). In some embodiments, the first container lid latch coupler 908 may be coupled to the first container lid latch body 907 such that the first container lid latch coupler 908 protrudes from the first container lid latch body 907. In some embodiments, the first container lid latch coupler 908 is integrally formed with the first container lid latch body 907.

The container base 902 further includes a second container base sidewall 914. The second container base sidewall 914 is contiguous with the first container base sidewall 904 and the container base bottom wall 903. In various embodiments, the second container base sidewall 914 may be coupled to at least one of the first container base sidewall 904 or the container base bottom wall 903. In some embodiments, the second container base sidewall 914 is integrally formed with at least one of the container base bottom wall 903 or the first container base sidewall 904. The container base 902 includes a first container base handle 916. the first container base handle 916 is coupled to the second container base sidewall 914. In some embodiments, the first container base handle 916 is integrally formed with the second container base sidewall 914.

The container base 902 includes a third container base sidewall 922. The third container base sidewall 922 is contiguous with the container base bottom wall 903 and the second container base sidewall 914. In various embodiments, the third container base sidewall 922 may be coupled to at least one of the second container base sidewall 914 or the container base bottom wall 903. In some embodiments, the third container base sidewall 922 is integrally formed with at least one of the container base bottom wall 903 or the second container base sidewall 914. The container base 902 includes a second container lid latch 923 (e.g., flange, clasp, etc.). The second container lid latch 923 is coupled to the third container base sidewall 922. In some embodiments, the second container lid latch 923 is integrally formed with the third container base sidewall 922. The second container lid latch 923 is configured to couple a container lid 928 of the adaptable container assembly 900, as described herein, to the container base 902.

The container base 902 includes a fourth container base sidewall 924. The fourth container base sidewall 924 is contiguous with the container base bottom wall 903, the first container base sidewall 904, and the third container base sidewall 922. In various embodiments, the fourth container base sidewall 924 may be coupled to at least one of the third container base sidewall 922, the first container base sidewall 904, or the container base bottom wall 903. In some embodiments, the fourth container base sidewall 924 is integrally formed with at least one of the container base bottom wall 903, the first container base sidewall 904, or the third container base sidewall 922. In some embodiments, container base bottom wall 903, the first container base sidewall 904, the second container base sidewall 914, the third container base sidewall 922, and the fourth container base sidewall 924 form a container base void 925.

The adaptable container assembly 900 of FIG. 9 further includes a container lid 928. The container lid 928 includes a container lid top wall 929. The container lid 928 includes a first container lid sidewall 930. The first container lid sidewall 930 is contiguous with the container lid top wall 929. In some embodiments, the first container lid sidewall 930 may be coupled to the container lid top wall 929. In some embodiments, the first container lid sidewall 930 is integrally formed with the container lid top wall 929. The container lid 928 includes a first container lid lock 932 (e.g., ridge, pin, button, etc.). The first container lid lock 932 is coupled to the first container lid sidewall 930. In some embodiments, the first container lid lock 932 is integrally formed with the first container lid sidewall 930.

In operation, the first container lid lock 932 is configured to receive the first container lid latch 906. A user may fold the first container lid latch 906 so that the first container lid latch coupler 908 and the first container lid lock 932 become coupled. Here, because the first container lid latch coupler 908 protrudes from the first container lid latch body 907, the protruded portion creates an interference fit with the first container lid lock 932. This enables the container lid 928 to be coupled to the container base 902 such that the first container lid sidewall 930 lies flush with the first container base sidewall 904. The first container lid sidewall 930 also includes at least one hole 934. In some embodiments, the first container lid sidewall 930 includes one to five holes 934. The hole 934 is configured to facilitate enhanced heat transfer through the adaptable container assembly 900. This enhanced heat transfer may be desirable when, for example, the container base void 925 is filled with food and the container lid 928 covers the container base 902 and it is desired to heat the food. Further, in some embodiments, the hole 934 includes a screen 935. The screen 935 is configured to restrict passing of cross-contaminants through the hole 934.

Further, the container lid 928 includes at least one steaming lid peg 936 (e.g., post, projection, protrusion, etc.). In some embodiments, the container lid 928 includes at least two or more steaming lid pegs 936. In some embodiments, a second steaming lid peg is coupled to the third container lid sidewall 940. In operation, the steaming lid peg 936 is coupled to the first container lid sidewall 930. In operation, the steaming lid peg 936 is configured to receive the steaming lid, as described herein.

Further, the container lid 928 includes a second container lid sidewall 937. The second container lid sidewall 937 is contiguous with the first container lid sidewall 930 and the container lid top wall 929. In various embodiments, the second container lid sidewall 937 may be coupled to at least one of the first container lid sidewall 930 or the container lid top wall 929. In some embodiments, the second container lid sidewall 937 is integrally formed with at least one of the first container lid sidewall 930 or the container lid top wall 929.

The container lid 928 also includes a third container lid sidewall 940. The third container lid sidewall 940 may be coupled to at least one of the second container lid sidewall 937 or the container lid top wall 929. In some embodiments, the third container lid sidewall 940 is integrally formed with at least one of the second container lid sidewall 937 or the container lid top wall 929. Further, in some embodiments, the third container lid sidewall 940 includes at least one hole 934. The hole 934 is configured to facilitate enhanced heat transfer through the adaptable container assembly 900. The hole 934, in some embodiments, includes a screen 935. In some embodiments, the third container lid sidewall includes a second container lid lock.

The container lid 928 includes a fourth container lid sidewall 942. The fourth container lid sidewall 942 is contiguous with the first container lid sidewall 930, the third container lid sidewall 940 and the container lid top wall 929. In various embodiments, the fourth container lid sidewall 942 may be coupled to at least one of the first container lid sidewall 930, the third container lid sidewall 940, or the container lid top wall 929. In some embodiments, the fourth container lid sidewall 942 is integrally formed with at least one of the first container lid sidewall 930, the third container lid sidewall 940, or the container lid top wall 929. The fourth container lid sidewall 942 includes at least one hole 934 configured to allow heat to enter and exit the container base void 925 when the container lid 928 is flush with the container base 902.

Further, the adaptable container assembly 900 of FIG. 9 includes a hinge mechanism 946. In some embodiments, the hinge mechanism includes a container base hinge flange, a container lid hinge flange, and a pivoting rod. In some embodiments, the container base hinge flange and the container lid hinge flange are coupled to outer surfaces of the fourth container base sidewall 924 and fourth container lid sidewall 942 respectively. In some embodiments, the hinge mechanism 946 is integrally formed with at least one of the container base 902 or the container lid 928. The hinge mechanism 946 enables the container lid 928 to be hingedly connected to the container base 902. The container lid 928 also includes a container lid viewing panel 948. The container lid viewing panel 948, in some embodiments, is a translucent material or a transparent material, which facilitates a user to view the food placed within the container base void 925.

The adaptable container assembly 900 of FIG. 9 further includes a steaming lid 950. The steaming lid 950 is configured to fit above the container lid 928 such that it covers the at least one holes 934. The steaming lid 950 includes a steaming lid container wall 951 and a first steaming lid sidewall 952. The first steaming lid sidewall 952 is contiguous with the steaming lid container wall 951. In some embodiments, the first steaming lid sidewall 952 is integrally formed with the steaming lid container wall 951. In various embodiments, the first steaming lid sidewall 952 may be coupled to the steaming lid container wall 951. The first steaming lid sidewall 952 includes a first peg receiving notch 953. The first peg receiving notch 953 is configured to couple to the steaming lid peg 936. The adaptable container assembly 900 further includes at least one steaming lid pivot 954. The steaming lid pivot 954 couples the steaming lid 950 to the container lid 928 such that the steaming lid 950 is hingedly connected. In some embodiments, the steaming lid pivot 954 is a rivet, a peg, a rod, or another similar structure which enables the steaming lid 950 to be hingedly connected to the container lid. In some embodiments, the steaming lid pivot 954 is a protruded peg that is coupled at least to the first container lid sidewall 930 and configured such that the steaming lid 950 may be coupled and rotatably coupled via an interference fit. In this embodiment, a user may push the protruded peg through a hole on the first steaming lid sidewall 952. This configuration may enable removal of the steaming lid 950 from the container lid 928.

The steaming lid 950 further includes a steaming lid void 956. The steaming lid void 956 enables covering of the container lid 928 by the steaming lid 950 when the steaming lid void 956 is rotated to a closed position. The steaming lid 950 further includes a third steaming lid sidewall 960. The third steaming lid sidewall 960 is contiguous with the steaming lid container wall 951. In various embodiments, the third steaming lid sidewall 960 may be coupled to the steaming lid container wall 951. In some embodiments, the third steaming lid sidewall 960 is integrally formed with the steaming lid container wall 951. The third steaming lid sidewall 960 includes a second peg receiving notch 958. The second peg receiving notch 958 is configured to couple to another steaming lid peg. In operation, a user may rotate the steaming lid about the steaming lid pivot 954 until the first peg receiving notch 953 contacts the ate least one steaming lid peg 936 and the second peg receiving notch 958 contacts another steaming lid peg. This couples the steaming lid 950 to the container lid 928. Additionally, when the steaming lid 950 is closed the holes 934 on the container lid 928 are covered by the steaming lid 950.

The steaming lid 950 further includes a fourth steaming lid sidewall 962. The fourth steaming lid sidewall 962 is contiguous with the first steaming lid sidewall 952, the third steaming lid sidewall 960 and the steaming lid container wall 951. In various embodiments the fourth steaming lid sidewall 962 may be coupled to at least the first steaming lid sidewall 952, the third steaming lid sidewall or the steaming lid container wall 951. In some embodiments, the fourth steaming lid sidewall 962 is integrally formed with at least one of the first steaming lid sidewall 952, the third steaming lid sidewall 960, or the steaming lid container wall 951. The steaming lid 950 includes a steaming lid viewing panel 964. The steaming lid viewing panel 964, in some embodiments, is a transparent material, which facilitates a user to view the food placed within the container base void 925.

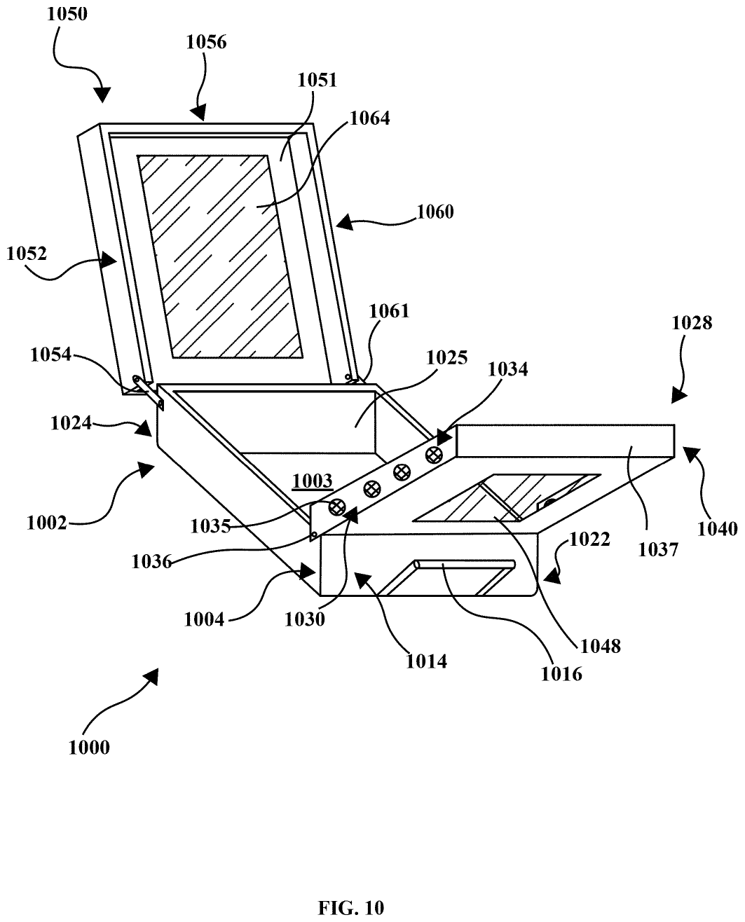

FIG. 10 is an adaptable container assembly 1000 in some embodiments. The adaptable container assembly 900 is analogous to the adaptable container assembly 100 described herein, and like reference numerals and/or component names indicate analogous components with analogous descriptions, unless otherwise indicated. The adaptable container assembly 1000 includes the container base 1002. The container base 1002 includes a first container base sidewall 1004. The first container base sidewall 1004 is contiguous with the container base bottom wall 1003. In various embodiments, the first container base sidewall 1004 may be coupled to the container base bottom wall 1003. In some embodiments, the first container base sidewall 1004 is integrally formed with the container base bottom wall 1003.

The container base 1002 further includes a second container base sidewall 1014. The second container base sidewall 1014 is contiguous with the container base bottom wall 1003 and the first container base sidewall 1004. In various embodiments, the second container base sidewall 1014 may be coupled to at least the first container base sidewall 1004 or the container base bottom wall 1003. In some embodiments, the second container base sidewall 1014 is integrally formed with at least one of the container base bottom wall 1003 or the first container base sidewall 1004. The container base 1002 includes a first container base handle 1016. The first container base handle 1016 may be coupled to the second container base sidewall 1014. In some embodiments, the first container base handle 1016 is integrally formed with the second container base sidewall 1014.

The container base 1002 includes a third container base sidewall 1022. The third container base sidewall 1022 is contiguous with the container base bottom wall 1003 and the second container base sidewall 1014. In various embodiments, the third container base sidewall 1022 may be coupled to at least one of the second container base sidewall 1014 or the container base bottom wall 1003. In some embodiments, the third container base sidewall 1022 is integrally formed with at least one of the container base bottom wall 1003 or the second container base sidewall 1014.

The container base 1002 includes a fourth container base sidewall 1024. The fourth container base sidewall 1024 is contiguous with the container base bottom wall 1003, the first container base sidewall 1004, and the third container base sidewall 1022. In various embodiments, the fourth container base sidewall 1024 may be coupled to at least one of the third container base sidewall 1022, the first container base sidewall 1004, or the container base bottom wall 1003. In some embodiments, the fourth container base sidewall 1024 is integrally formed with at least one of the container base bottom wall 1003, the first container base sidewall 1004, or the third container base sidewall 1022. In some embodiments, container base bottom wall 1003, the first container base sidewall 1004, the second container base sidewall 1014, the third container base sidewall 1022, and the fourth container base sidewall 1024 form a container base void 1025.

The adaptable container assembly 1000 of FIG. 10 further includes a container lid 1028. The container lid 1028 includes a container lid top wall 1029. The container lid 1028 includes a first container lid sidewall 1030. The first container lid sidewall 1030 is contiguous with the container lid top wall 1029. In various embodiments, the first container lid sidewall 1030 may be coupled to the container lid top wall 1029. In some embodiments, the first container lid sidewall 1030 is integrally formed with the container lid top wall 1029. The first container lid sidewall 1030 also includes at least one hole 1034. In some embodiments, the first container lid sidewall 1030 includes one to five holes 1034. The hole 1034 is configured to facilitate enhanced heat transfer through the adaptable container assembly 1000. This enhanced heat transfer may be desirable when, for example, the container base void 1025 is filled with food and the container lid 1028 covers the container base 1002 and it is desired to heat the food. Further, in some embodiments, the hole 1034 includes a screen 1035. The screen 1035 is configured to restrict passing of cross-contaminants through the hole 1034.

The adaptable container assembly 1000 further includes at least one container lid pivot 1036. The container lid pivot 1036 couples the container lid 1028 to the container base 1002 such that the container lid 1028 is hingedly connected. In some embodiments, the container lid pivot 1036 is a rivet, a peg, a rod, or another similar structure which enables the container lid 1028 to be hingedly connected to the container lid 1028. In some embodiments, the container lid pivot 1036 is a protruded peg that is coupled at least to the first container base sidewall 1004 and configured such that the container lid 1028 may be coupled and rotatably coupled via an interference fit. In this embodiment, a user may push the protruded peg through a hole on the first container lid sidewall 1030. This configuration may enable removal of the container lid 1028 from the container base 1002.

Further, the container lid 1028 includes a second container lid sidewall 1037. The second container lid sidewall 1037 is contiguous with the first container lid sidewall 1030 and the container lid top wall 1029. In various embodiments, the second container lid sidewall 1037 may be coupled to at least one of the first container lid sidewall 1030 or the container lid top wall 1029. In some embodiments, the second container lid sidewall 1037 is integrally formed with at least one of the first container lid sidewall 1030 or the container lid top wall 1029.

The container lid 1028 also includes a third container lid sidewall 1040. The third container lid sidewall 1040 is contiguous with the second container lid sidewall 1037 and the container lid top wall 1029. In various embodiments, the third container lid sidewall 1040 may be coupled to of the second container lid sidewall 1037 or the container lid top wall 1029. In some embodiments, the third container lid sidewall 1040 is integrally formed with at least one of the second container lid sidewall 1037 or the container lid top wall 1029. Further, in some embodiments, the third container lid sidewall 1040 includes the hole 1034. The hole 1034 is configured to facilitate enhanced heat transfer through the adaptable container assembly 1000. In some embodiments, the hole 1034 includes the screen 1035. In some embodiments, the container lid pivot 1036 is also located on the third container lid sidewall 1040. The container lid 1028 also includes a container lid viewing panel 1048. The container lid viewing panel 1048, in some embodiments, is a translucent material or a transparent material which facilitates a user to view the food placed within the container base void 1025.

The adaptable container assembly 1000 of FIG. 10 further includes a steaming lid 1050. The steaming lid 1050 is configured to fit above the container lid 1028 such that it covers the hole 1034. The steaming lid 1050 includes a steaming lid top wall 151 and a first steaming lid sidewall 1052. The first steaming lid sidewall 1052 is contiguous with the steaming lid container wall 1051. In some embodiments, the first steaming lid sidewall 1052 is integrally formed with the steaming lid container wall 1051. In some embodiments, the first steaming lid sidewall 1052 may be coupled to the steaming lid container wall 1051.

Further, the adaptable container assembly 1000 of FIG. 10 further includes a first steaming lid hinge 1054. The first steaming lid hinge 1054 is coupled at one end to the first container base sidewall 1004 and at another end to the first steaming lid sidewall 1052. The first steaming lid hinge 1054 is configured to hingedly connect the steaming lid 1050 to the container base 1002.

The steaming lid 1050 further includes a second steaming lid sidewall 1056. The second steaming lid sidewall 1056 is contiguous with the first steaming lid sidewall 1052 and the steaming lid container wall 1051. The second steaming lid sidewall 1056 may be coupled to at least one of the first steaming lid sidewall 1052 or the steaming lid container wall 1051. In some embodiments, the second steaming lid sidewall 1056 is integrally formed with the first steaming lid sidewall 1052 and the steaming lid container wall 1051.

The steaming lid 1050 further includes a third steaming lid sidewall 1060. The third steaming lid sidewall 1060 is contiguous with the second steaming lid sidewall 1056, and the steaming lid container wall 1051. In various embodiments, the third steaming lid sidewall 1060 may be coupled to at least one of the second steaming lid sidewall 1056 or the steaming lid container wall 1051. In some embodiments, the third steaming lid sidewall 1060 is integrally formed with at least one of the second steaming lid sidewall 1056 or the steaming lid container wall 1051.

Further, the adaptable container assembly 1000 of FIG. 10 further includes a second steaming lid hinge 1061 in some embodiments. The second steaming lid hinge 1061 is coupled at one end to the third container base sidewall 1022 and at another end to the third steaming lid sidewall 1060. The second steaming lid hinge 1061 is configured to hingedly connect the steaming lid 1050 to the container base 1002. In operation, a user is able to rotate the steaming lid 1050 over the container lid 1028, when the container lid 1028 in the closed position. Once the user closes the container lid 1028, the user positions the first steaming lid hinge 1054 and the second steaming lid hinge 1061 in a vertical position such that the steaming lid 1050 is perpendicular with the container lid 1028 when the container lid 1028 is in a closed position. The user than rotates the steaming lid 1050 over the container lid 1028 such that the steaming lid 1050 is positioned over the container lid 1028. In some embodiments, a user may rotate the steaming lid 1050 over the container base 1002 while having the container lid 1028 in the open position. The steaming lid 1050 includes a steaming lid viewing panel 164. The steaming lid viewing panel 1064, in some embodiments, is a transparent material, which facilitates a user to view the food placed within the container base void 1025. In some embodiments, the steaming lid viewing panel 1064 is made from glass.

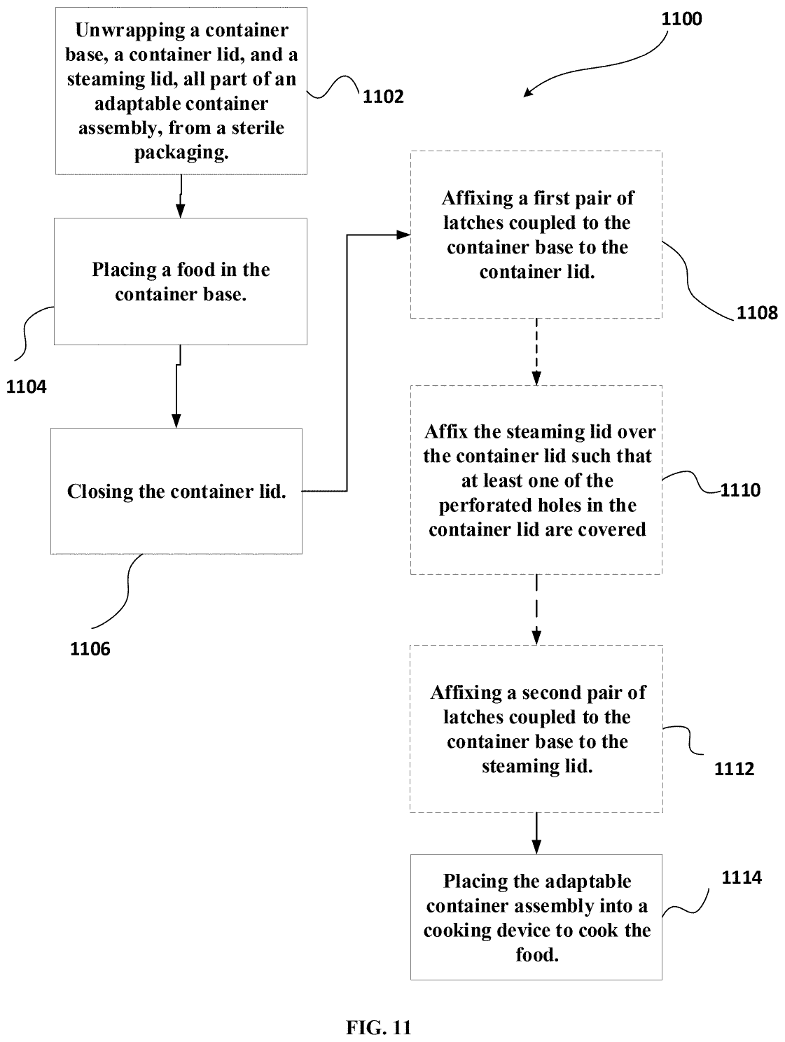

FIG. 11 illustrates a process 1100 (e.g., method, etc.) for using the adaptable container assembly 100. The process 1100 begins in step 1102, where a user unwraps the adaptable container assembly 100 from sterile packaging. The user unwraps the container base 102, the container lid 128, and the steaming lid 150 from the sterile packaging and places the container base 102, the container lid 128, and the steaming lid 150 in a sterile environment away from possible contaminants.

The process 1100 continues in step 1104, where the user places the food that is to be cooked, transported, and/or stored in the container base 102. The food maybe a finished product ready to cook that was prepared outside of the adaptable container assembly 100. In some embodiments, the food is the various ingredients used to prepare the food. In this embodiment, the user may prepare the food directly in the container base 102.

The process 1100 continues in step 1106, where the user closes the container lid 128 such that it covers the food in the container base 102. In some embodiments, the container lid 128 is closed via a hinge mechanism. In some embodiments, the container lid 128 is closed via an interference fit, such as described with reference to FIG. 8.

In some embodiments, the process 1100 continues instep 1108, where the user affixes a first pair of latches to the container lid 128. First, a user may fold the first container lid latch 106 so that the first container lid latch coupler 108 and the first container lid lock 132 become coupled, such as described with reference to FIGS. 1, 2, and 3. Then, a user may fold the second container lid latch 206 so that the second container lid latch coupler 208 and the second container lid lock 304 become coupled, such as described with reference to FIGS. 1, 2, and 3.

In some embodiments, the process 1100 continues in step 1110, where the user couples the steaming lid 150 over the container lid 128 such that at least one hole 134 is covered. In some embodiments, the steaming lid 150 is coupled to the container lid 128 via a hinge mechanism. In some embodiments, the steaming lid 150 is coupled to the container lid 128 via an interference fit.

In some embodiments, the process 1100 continues in step 1112, where the user affixes a second pair of latches coupled to the container base 102 to the steaming lid 150. The user folds the first steaming lid latch 110 such that the first steaming lid latch coupler 112 is coupled to the first steaming lid lock 154, as described with reference to FIGS. 1, 2, and 4. The user, then, folds the second steaming lid latch 118 such that the second steaming lid latch coupler 120 is coupled to the second steaming lid lock 158, as described with reference to FIGS. 1, 2, and 4. The user a user folds the third steaming lid latch 210 such that the third steaming lid latch coupler 212 is coupled to the third steaming lid lock 402, as described with reference to FIGS. 1, 2, and 4. Lastly, in step 1112, a user folds the fourth steaming lid latch 218 such that the fourth steaming lid latch coupler 220 is coupled to the fourth steaming lid lock 404, as described with reference to FIGS. 1, 2, and 4.

The process 1100 continues in step 1114, where the user places the adaptable container assembly 100 into a cooking device to cook the food. The cooking device may be an oven, a microwave, a grill etc.

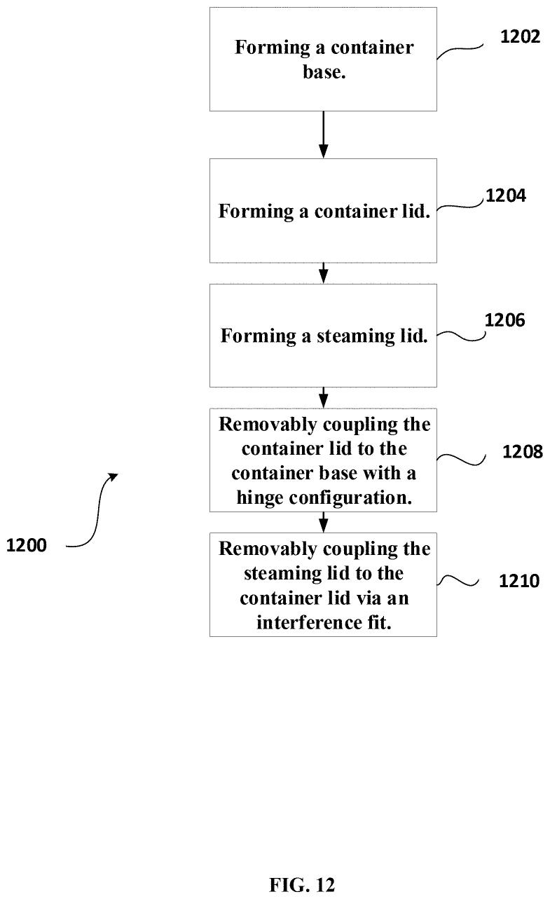

FIG. 12 depicts a process 1200 (e.g., method, etc.) of manufacturing the adaptable container assembly 100 in some embodiments. The process 1200 includes in step 1202, where a container base 102 is formed. The container base 102 may be formed via injection molding, blow-molding, milling, casting, machining, welding, bending, folding, forming, or other similar manufacturing processes.

The process 1200 continues in step 1204, where a container lid 128 is formed. The container lid 128 may be formed via injection molding, blow-molding, milling, casting, machining, welding, bending, folding, forming, or other similar manufacturing processes.

Additionally, in forming the container lid 128, at least one hole 134 is formed through the container lid 128, in some embodiments. Further, in some embodiments, a container lid viewing panel 148 is embedded into the container lid 128 when it is formed. In some embodiments, the container lid viewing panel 148 is integrally formed with the container lid 128. In some embodiments, the container lid 128 is constructed from two portions and the container lid viewing panel 148 is first positioned between the two portions and the two portions are subsequently coupled such that the container lid viewing panel 148 is embedded within the two portions In some embodiments, the container lid viewing panel 148 is coupled to the container lid 128 using an adhesive (e.g., glue, room temperature vulcanizing (RTV) silicone, etc.).

The process 1200 continues in step 1206, where a steaming lid 150 is formed. The steaming lid 150 may be formed via injection molding, blow-molding, milling, casting, machining, welding, bending, folding, forming, or other similar manufacturing processes. In some embodiments, a steaming lid viewing panel 164 is embedded into the steaming lid 150 when it is formed. In some embodiments, the steaming lid viewing panel 164 is integrally formed with the steaming lid 150. In some embodiments, the steaming lid top wall 151 is constructed from two portions and the steaming lid viewing panel 164 is first positioned between the two portions and the two portions are subsequently coupled such that the steaming lid viewing panel 164 is embedded within the two portions. In some embodiments, the steaming lid viewing panel 164 is coupled to the steaming lid 150 using an adhesive.

The process 1200 continues in step 1208, where the container lid 128 is coupled to the container base 102 with a hinge configuration. The container lid 128 is hingedly connected to the container base 102 via the container base hinge flange 126, the pivoting rod 146, and the container lid hinge flange 144, as described with reference to FIG. 1. In some embodiments, the container lid hinge flange 144 is coupled to an inside surface of the fourth container lid sidewall 142. The container base hinge flange 126 is coupled to the fourth container base sidewall 124. Further, a pivoting rod 146 is then coupled to the container base hinge flange 126 and the container lid hinge flange 144. This enables the container lid 128 to be rotated towards and away from the container base 102.

The process 1200 continues in step 1210, where the steaming lid 150 is coupled to the container lid 128 via an interference fit. The steaming lid 150 is placed on top of the container lid 128 and pushed down such that the steaming lid 150 covers the hole 134 on the container lid 128.

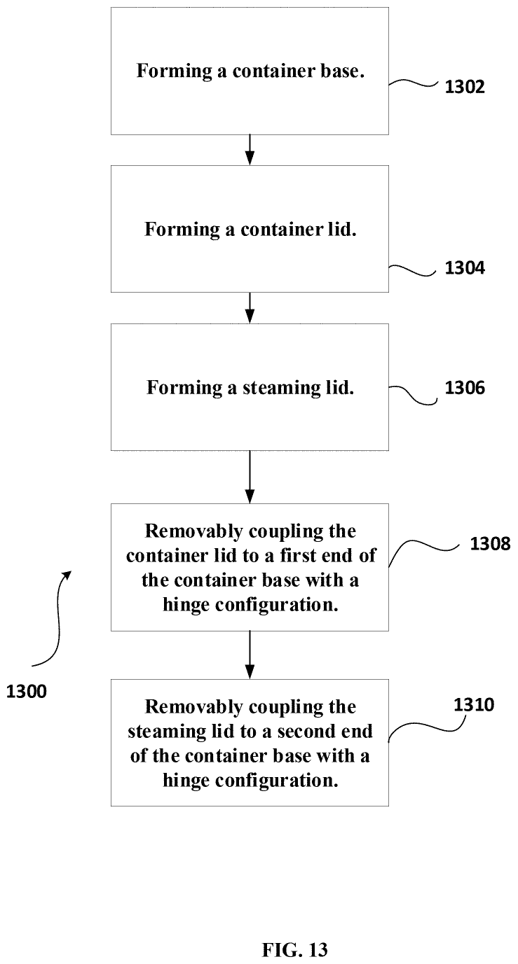

FIG. 13 depicts a process 1300 (e.g., method, etc.) of manufacturing the adaptable container assembly 100 in some embodiments. The process 1300 begins in step 1302, where a container base 102 is formed. The container base 102 may be formed via injection molding, blow-molding, milling, casting, machining, welding, bending, folding, forming, or other similar manufacturing process.

The process 1300 continues in step 1304, where a container lid 128 is formed. The container lid 128 may be formed via injection molding, blow-molding, milling, casting, machining, welding, bending, folding, forming, or other similar manufacturing processes. Additionally, in forming the container lid 128, at least one hole 134 is formed through the container lid 128, in some embodiments. Further, in some embodiments, a container lid viewing panel 148 is embedded into the container lid 128 when it is formed. In some embodiments, the container lid viewing panel 148 is integrally formed with the container lid 128. In some embodiments, the container lid 128 is constructed from two portions and the container lid viewing panel 148 is first positioned between the two portions and the two portions are subsequently coupled such that the container lid viewing panel 148 is embedded within the two portions In some embodiments, the container lid viewing panel 148 is coupled to the container lid 128 using an adhesive.

The process 1300 continues in step 1306, where a steaming lid 150 is formed. The steaming lid 150 may be formed via injection molding, blow-molding, milling, casting, machining, welding, bending, folding, forming, or other similar manufacturing processes. In some embodiments, a steaming lid viewing panel 164 is embedded into the steaming lid 150 when it is formed. In some embodiments, the steaming lid viewing panel 164 is integrally formed with the steaming lid 150. In some embodiments, the steaming lid top wall 151 is constructed from two portions and the steaming lid viewing panel 164 is first positioned between the two portions and the two portions are subsequently coupled such that the steaming lid viewing panel 164 is embedded within the two portions. In some embodiments, the steaming lid viewing panel 164 is coupled to the steaming lid 150 using an adhesive.

The process 1300 continues in step 1308, where the container lid 128 is coupled to the container base 102 via a hinge configuration. The adaptable container assembly 100 further includes container lid pivot 1036, as described with reference to FIG. 10. The container lid pivot 1036 is formed with a rivet, a peg, a rod, or another similar structure which enables the container lid 128 to be hingedly connected to the container base 102.

The process 1300 continues in step 1310, where the steaming lid 150 is coupled to the container base 102 via a hinge configuration. The steaming lid 150 is hingedly connected using a first steaming lid hinge 1054 and a second steaming lid hinge 1061, as described with reference to FIG. 10. The first steaming lid hinge 1054 is coupled at one end to the first container base sidewall 104 and at another end to the first steaming lid sidewall 152. The second steaming lid hinge 1061 is coupled at one end to the third container base sidewall 122 and at another end to the third steaming lid sidewall 160.

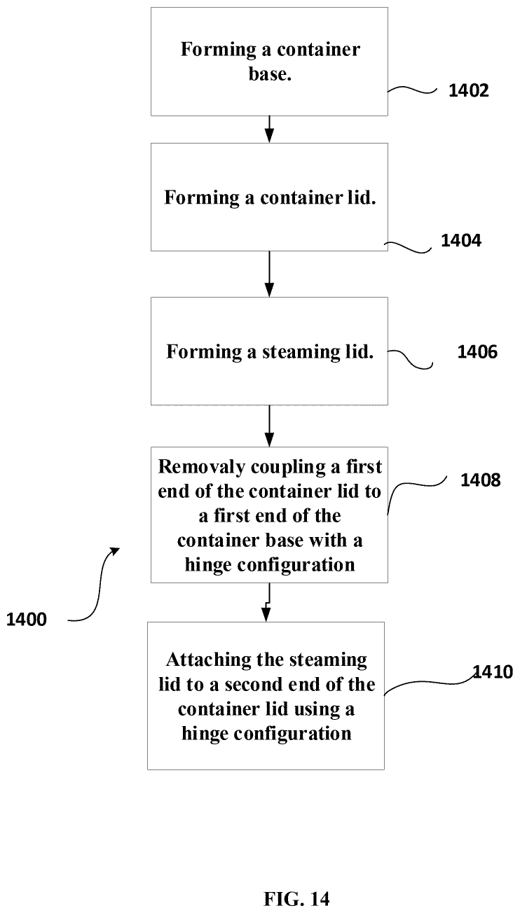

FIG. 14 depicts a process 1400 (e.g., method, etc.) of manufacturing the adaptable container assembly 100 in some embodiments. The process 1400 begins in step 1402, where a container base 102 is formed. The container base 102 may be formed via injection molding, blow-molding, milling, casting, machining, welding, bending, folding, forming, or other similar manufacturing processes.

The process 1400 continues in step 1404, where a container lid 128 is formed. The container lid 128 may be formed via injection molding, blow-molding, milling, casting, machining, welding, bending, folding, forming, or other similar manufacturing processes. Additionally, in forming the container lid 128, at least one hole 134 is formed through the container lid 128, in some embodiments. Further, in some embodiments, a container lid viewing panel 148 is embedded into the container lid 128 when it is formed. In some embodiments, the container lid viewing panel 148 is integrally formed with the container lid 128. In some embodiments, the container lid 128 is constructed from two portions and the container lid viewing panel 148 is first positioned between the two portions and the two portions are subsequently coupled such that the container lid viewing panel 148 is embedded within the two portions In some embodiments, the container lid viewing panel 148 is coupled to the container lid 128 using an adhesive.

The process 1400 continues in step 1406, where a steaming lid 150 is formed. The steaming lid 150 may be formed via injection molding, blow-molding, milling, casting, machining, welding, bending, folding, forming, or other similar manufacturing processes. In some embodiments, a steaming lid viewing panel 164 is embedded into the steaming lid 150 when it is formed. In some embodiments, the steaming lid viewing panel 164 is integrally formed with the steaming lid 150. In some embodiments, the steaming lid top wall 151 is constructed from two portions and the steaming lid viewing panel 164 is first positioned between the two portions and the two portions are subsequently coupled such that the steaming lid viewing panel 164 is embedded within the two portions. In some embodiments, the steaming lid viewing panel 164 is coupled to the steaming lid 150 using an adhesive.

The process 1400 continues in step 1408, where the container lid 128 is coupled to a first end of the container base 102 with a hinge configuration. The container lid 128 is hingedly connected to the container base 102 via the container base hinge flange 126, the pivoting rod 146, and the container lid hinge flange 144, as described with reference to FIG. 9. The container lid 128 is hingedly connected to the container base 102 via the container base hinge flange 126, the pivoting rod 146, and the container lid hinge flange 144, as described with reference to FIG. 1. In some embodiments, the container lid hinge flange 144 is coupled to the fourth container lid sidewall 142. The container base hinge flange 126 is coupled to the fourth container base sidewall 124. Further, a pivoting rod 146 is then coupled to the container base hinge flange 126 and the container lid hinge flange 144. This enables the container lid 128 to be rotated towards and away from the container base 102.

The process 1400 continues in step 1410, where the steaming lid 150 is coupled to a second end of the container lid 128, as described with reference to FIG. 9. The steaming lid pivot 954, as described with reference to FIG. 9, couples the steaming lid 150 to the container lid 128 such that the steaming lid 150 is hingedly connected. In some embodiments, the steaming lid pivot 954 is a rivet, a peg, a rod, or another similar structure which enables the steaming lid 150 to be hingedly connected to the container lid. In some embodiments, the steaming lid pivot 954 is a protruded peg that is coupled at least to the first container lid sidewall 130 and configured such that the steaming lid 150 may be coupled and rotatably coupled via an interference fit.

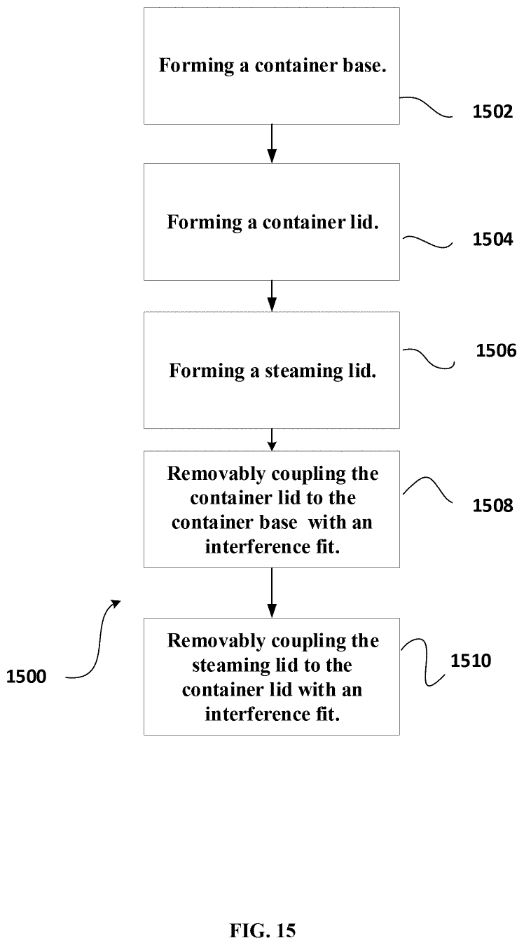

FIG. 15 depicts a process 1500 (e.g., method, etc.) of manufacturing the adaptable container assembly 100 in some embodiments. The process 1500 begins in step 1502, where a container base 102 is formed. The container base 102 may be formed via injection molding, blow-molding, milling, casting, machining, welding, bending, folding, forming, or other similar manufacturing processes.

The process 1500 continues in step 1504, where a container lid 128 is formed. The container lid 128 may be formed via injection molding, blow-molding, milling, casting, machining, welding, bending, folding, forming, or other similar manufacturing processes. Additionally, in forming the container lid 128, at least one hole 134 is formed through the container lid 128, in some embodiments. Further, in some embodiments, a container lid viewing panel 148 is embedded into the container lid 128 when it is formed. In some embodiments, the container lid viewing panel 148 is integrally formed with the container lid 128. In some embodiments, the container lid 128 is constructed from two portions and the container lid viewing panel 148 is first positioned between the two portions and the two portions are subsequently coupled such that the container lid viewing panel 148 is embedded within the two portions In some embodiments, the container lid viewing panel 148 is coupled to the container lid 128 using an adhesive.

The process 1500 continues in step 1506, where a steaming lid 150 is formed. The steaming lid 150 may be formed via injection molding, blow-molding, milling, casting, machining, welding, bending, folding, forming, or other similar manufacturing processes. In some embodiments, a steaming lid viewing panel 164 is embedded into the steaming lid 150 when it is formed. In some embodiments, the steaming lid viewing panel 164 is integrally formed with the steaming lid 150. In some embodiments, the steaming lid top wall 151 is constructed from two portions and the steaming lid viewing panel 164 is first positioned between the two portions and the two portions are subsequently coupled such that the steaming lid viewing panel 164 is embedded within the two portions. In some embodiments, the steaming lid viewing panel 164 is coupled to the steaming lid 150 using an adhesive.

The process 1500 continues in step 1508, where the container lid 128 is coupled to the container base 102 via an interference fit. The container lid 128 is placed on top of the container base 102 and pushed down such that the container lid 128 fits over the container base 102. In step 1510, the steaming lid 150 is coupled to the container lid 128. The steaming lid 150 is placed on top of the container lid 128 and pushed down such that the steaming lid 150 fits over the container lid 128.

### III. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. An adaptable container assembly comprising:
a container base partially enclosing a container base void that is configured to receive a food, the container base comprising:
a first container base sidewall, and
a container base bottom wall contiguous with the first container base sidewall;
a container lid configured to enclose the container base void, the container lid comprising a first container lid sidewall coupled to the first container base sidewall; and
a steaming lid comprising a first steaming lid sidewall coupled to the first container lid sidewall, the steaming lid cooperating with the container base to enclose the container lid between the container base and the steaming lid.

2. The adaptable container assembly of claim 1, wherein:
the container base further comprises:
a second container base sidewall contiguous with the first container base sidewall,
a third container base sidewall contiguous with the second container base sidewall, and
a fourth container base sidewall contiguous with the first container base sidewall and the third container base sidewall; and
the container base bottom wall cooperates with the first container base sidewall, the second container base sidewall, the third container base sidewall, and the fourth container base sidewall to partially enclose the container base void.

3. The adaptable container assembly of claim 2, wherein the container base further comprises:
a container base hole on one of the first container base sidewall, the second container base sidewall, the third container base sidewall, or the fourth container base sidewall; and
a screen extending across the container base hole.

4. The adaptable container assembly of claim 2, wherein:
the container base further comprises a first container base handle coupled to the second container base sidewall and projecting from the second container base sidewall; and
the container lid further comprises a second container lid sidewall contiguous with the first container lid sidewall; and
the container lid further comprises a container lid handle coupled to the second container lid sidewall and projecting from the second container lid sidewall.

5. The adaptable container assembly of claim 4, further comprising:
a container lid latch coupled to one of the first container base sidewall, the second container base sidewall, the third container base sidewall, or the fourth container base sidewall; and
a container lid lock coupled to one of the first container lid sidewall or the second container lid sidewall.

6. The adaptable container assembly of claim 2, wherein the container lid further comprises:
a second container lid sidewall contiguous with the first container lid sidewall;
a third container lid sidewall contiguous with the second container lid sidewall;
a fourth container lid sidewall contiguous with the first container lid sidewall and the third container lid sidewall, the fourth container lid sidewall coupled to the fourth container base sidewall; and
a container lid top wall contiguous with the first container lid sidewall, the second container lid sidewall, the third container lid sidewall, and the fourth container lid sidewall.

7. The adaptable container assembly of claim 6, wherein the steaming lid further comprises:
a second steaming lid sidewall contiguous with the first steaming lid sidewall;
a third steaming lid sidewall contiguous with the second steaming lid sidewall;
a fourth steaming lid sidewall contiguous with the first steaming lid sidewall and the third container lid sidewall; and
a steaming lid container wall contiguous with the first steaming lid sidewall, the second steaming lid sidewall, the third steaming lid sidewall, and the fourth steaming lid sidewall.

8. The adaptable container assembly of claim 1, wherein the container lid further comprises:
a container lid top wall contiguous with the first container lid sidewall;
a hole located on at least one of the first container lid sidewall;
a screen coupled to the container lid and extending across the hole;
a container lid viewing panel coupled to the container lid top wall, the container lid viewing panel being translucent or transparent; and
an indicator coupled to the container lid.

9. The adaptable container assembly of claim 8, wherein the steaming lid further comprises:
a steaming lid container wall contiguous with the first steaming lid sidewall; and
a steaming lid viewing panel coupled to the steaming lid container wall and aligned with the container lid viewing panel, the steaming lid viewing panel being translucent or transparent.

10. An adaptable container assembly comprising:
a container base partially enclosing a container base void that is configured to receive a food, the container base comprising:
a first container base sidewall, and
a container base bottom wall contiguous with the first container base sidewall; and
a container lid comprising:
a first container lid sidewall,
a second container lid sidewall contiguous with the first container lid sidewall, and
a container lid top wall contiguous with the first container lid sidewall and the second container lid sidewall;
a hinge mechanism coupled to the first container lid sidewall and the first container base sidewall such that the container lid is hingedly coupled to the container base; and
a steaming lid comprising a first steaming lid sidewall pivotably coupled to the second container lid sidewall such that the steaming lid is hingedly coupled to the container lid.

11. The adaptable container assembly of claim 10, wherein:
the container lid further comprises:
a third container lid sidewall contiguous with the first container lid sidewall, and
a fourth container lid sidewall contiguous with the second container lid sidewall and the third container lid sidewall; and
the container lid top wall is contiguous with the third container lid sidewall, and the fourth container lid sidewall.

12. The adaptable container assembly of claim 11, wherein:
the steaming lid further comprises:
a second steaming lid sidewall contiguous with the first steaming lid sidewall,
a third steaming lid sidewall contiguous with the second steaming lid sidewall, and
a steaming lid container wall contiguous with the first steaming lid sidewall, the second steaming lid sidewall, and the third steaming lid sidewall; and
the second steaming lid sidewall, the third steaming lid sidewall, and the steaming lid container wall form a void, the void configured to receive the fourth container lid sidewall such that the steaming lid cooperates with the container lid to enclose the container base void.

13. The adaptable container assembly of claim 12, wherein:
the container lid further comprises a protrusion extending from the second container lid sidewall; and
the steaming lid further comprises a notch in the second steaming lid sidewall, the notch configured to receive the protrusion on the second container lid sidewall and configured to couple the steaming lid to the container lid.

14. The adaptable container assembly of claim 12, wherein the container lid further comprises a container lid viewing panel coupled to the container lid top wall, the container lid viewing panel being translucent or transparent.

15. The adaptable container assembly of claim 14, wherein:
the steaming lid further comprises a steaming lid viewing panel coupled to the steaming lid container wall; and
the steaming lid and the container lid are configured such that the container lid viewing panel is aligned with the steaming lid viewing panel when the steaming lid cooperates with the container lid to enclose to enclose the container lid top wall, the steaming lid viewing panel being translucent or transparent.

16. An adaptable container assembly comprising:
a container base partially enclosing a container base void that is configured to receive a food, the container base comprising:
a first container base sidewall; and
a container base bottom wall contiguous with the first container base sidewall;
a container lid comprising a first container lid sidewall coupled to the first container base sidewall;
a pivot mechanism pivotably coupling the first container lid sidewall to the first container base sidewall and configured to facilitate rotation of the container lid relative to the container base so as to cause the container lid to cooperate with the container base to enclose the container base void;
a steaming lid comprising a first steaming lid sidewall; and
a steaming lid hinge mechanism hingedly coupling the first steaming lid sidewall and the first container base sidewall and configured to facilitated movement of the steaming lid relative to the container base such that the steaming lid cooperates with the container base to enclose the container lid between the container base and the steaming lid in at least one position of the steaming lid relative to the container base.

17. The adaptable container assembly of claim 16, wherein the container lid further comprises:
a second container lid sidewall contiguous with the first container lid sidewall;
a third container lid sidewall contiguous with the second container lid sidewall; and
a container lid top wall contiguous with the first container lid sidewall, the second container lid sidewall, and the third container lid sidewall.

18. The adaptable container assembly of claim 17, wherein the steaming lid further comprises:
a second steaming lid sidewall contiguous with the first steaming lid sidewall;
a third steaming lid sidewall contiguous with the second steaming lid sidewall; and
a steaming lid container wall contiguous with the first steaming lid sidewall, the second steaming lid sidewall, and the third steaming lid sidewall.

19. The adaptable container assembly of claim 18 wherein:
the container lid further comprises a container lid viewing panel coupled to the container lid top wall, the container lid viewing panel being translucent or transparent;
the steaming lid further comprises a steaming lid viewing panel coupled to the steaming lid container wall; and
the steaming lid and the container lid are configured such that the container lid viewing panel is aligned with the steaming lid viewing panel when the steaming lid cooperates with the container lid to enclose to enclose the container lid top wall, the steaming lid viewing panel being translucent or transparent.

20. The adaptable container assembly of claim 17, wherein:
the container lid further comprises:
a hole located on at least one of the first container lid sidewall, the second container lid sidewall, the third container lid sidewall, and the container lid top wall, and
a screen coupled to the container lid and extending across the hole;
wherein when the first steaming lid sidewall couples with the first container lid sidewall, the first steaming lid sidewall extends across the hole and cooperates with the container lid to cover the hole and restricts escape of steam.
